(19) United States
(12) Patent Application Publication
(10) Pub. No.: US 2013/0125069 A1
(43) Pub. Date: May 16, 2013

(54) System and Method for Interactive Labeling of a Collection of Images

(71) Applicants: Lubomir D. Bourdev, San Jose, CA (US); Shmuel Avidan, Brookline, MA (US); Kevin T. Dale, Somerville, MA (US)

(72) Inventors: Lubomir D. Bourdev, San Jose, CA (US); Shmuel Avidan, Brookline, MA (US); Kevin T. Dale, Somerville, MA (US)

(21) Appl. No.: 13/408,889

(22) Filed: Feb. 29, 2012

Related U.S. Application Data
(60) Provisional application No. 61/531,566, filed on Sep. 6, 2011.

(51) Int. Cl. G06F 3/033; G06F 3/048

(52) U.S. Cl. 715/863

(57) ABSTRACT

Various embodiments of a system and method for labeling images are described. An image labeling system may label multiple images, where each of the images may be labeled to identify image content or image elements, such as backgrounds or faces. The system may display some of the labeled image elements in different portions of a display area. Unlabeled image elements may be displayed in the same display area. The display size and position of each unlabeled image element may be dependent on similarities between the unlabeled image element and the displayed, labeled image elements. The system may also receive gesture input in order to determine a corresponding labeling task to perform.

### BACKGROUND

Labeling large collections of images can be a daunting and time-consuming task. While some tools exist that provide a user with an interface for applying labels to a repository of images, these existing tools lack an intuitive and interactive interface that recognizes and makes use of the uncertainty in image recognition software and overcomes user interface limitations inherent in mobile or touch-screen devices. Particularly on mobile devices, screen space tends to be limited and the use of menus is often cumbersome and inefficient. Further, with respect to face labeling, conventional methods do not utilize the full knowledge computed by a facial recognition engine. Instead prior art methods may base decisions on a strict threshold of confidence for determining whether unlabeled faces are presented to a user with a suggested label. For example, a conventional face labeling system may be somewhat confident in a face match, but not confident enough to display the faces as a suggested match. In such a case, the conventional face labeling system provides no indication of partial confidence in a face match. Accordingly, a conventional face labeling system is typically either too conservative or too liberal in providing face label suggestions. With a conservative setting, a conventional face labeling system will only suggest labels and faces which are highly likely to be a match. This approach results in a lot of work for the user, as the system will not display many suggested faces and the user will need to manually label many faces. With a liberal setting, a conventional face labeling system will display labels and faces that have a lower likelihood of being a match. This approach may result in frustration for the user, as the user will be required to correct any mistakes made by the conventional face labeling system.

### SUMMARY

An image labeling system is disclosed, which provides a method for labeling a collection of images, and which makes use of gesture recognition and different levels of confidence within image recognition engines in order to intuitively present labeling results. For example, the image labeling system may provide a mechanism for a user to label images that appear in a collection of digital images. The image labeling system may display one or more labeled images within a user interface, where each one of the one or more labeled images is displayed within a different region of a user interface of the image labeling system. Also within the user interface, the image labeling system displays one or more unlabeled images, where an unlabeled image is displayed in a location within the user interface that is dependent on similarities between the unlabeled image and one or more of the labeled images. The location in which an unlabeled image is displayed may further depend on the levels of uncertainty resulting from an image recognition computation. The image labeling system may also receive user input defining a gesture, and determine a labeling task from among a plurality of labeling tasks based on one or more characteristics of the gesture.

### BRIEF DESCRIPTION OF THE DRAWINGS

FIG. 1 illustrates an example of an image labeling module which may be used to label image elements in a collection of images, according to some embodiments.

FIG. 2 is a flowchart of a method for labeling image elements in a collection of images, according to some embodiments.

FIG. 3 illustrates an example of a user interface which may include a display of labeled image elements and unlabeled image elements, according to some embodiments.

FIG. 4 illustrates an example of user selections of one or more unlabeled image elements using a rectangle selection tool, according to some embodiments.

FIG. 5 illustrates an example of user selections of one or more unlabeled image elements using a brush selection tool, according to some embodiments.

FIG. 6 illustrates an example of user selections of one or more unlabeled image elements using a lasso selection tool, according to some embodiments.

FIG. 7 illustrates an example of a display of unlabeled image elements that have been updated after receiving user input which indicates labels for one or more unlabeled image elements, according to some embodiments.

FIG. 8 illustrates an example of a new labeled image element that has been selected and placed in the display area, according to some embodiments.

FIG. 9 is a flowchart of a method for displaying unlabeled image elements in a display area, according to some embodiments.

FIG. 10 is a flowchart of a method for updating a display of unlabeled image elements in a display area, according to some embodiments.

FIG. 11 illustrates an example display of a source image for an image element, according to some embodiments.

FIG. 12 illustrates an example of a user applying a label directly to an unlabeled image element, according to some embodiments.

FIG. 13 illustrates an example of a user selecting unlabeled image elements for removal from the display area, according to some embodiments.

FIG. 14 illustrates an example computer system that may be used in some embodiments.

FIG. 15 illustrates an example cloud computing environment that may be used in some embodiments.

FIG. 16 illustrates an example of a user deleting an unlabeled image using a gesture, according to some embodiments.

FIG. 17 illustrates an example of a user flicking an unlabeled image toward a labeled image, according to some embodiments.

FIG. 18 illustrates an example of a user tracing a path on a screen to select multiple unlabeled images, according to some embodiments.

FIG. 19 illustrates an example of a user tracing a lasso path on a screen to select multiple unlabeled images, according to some embodiments.

FIG. 20 illustrates an example of a user renaming a labeled image, according to some embodiments.

FIG. 21 illustrates an example of a user replacing one labeled image with another labeled images, according to some embodiments.

FIG. 22 illustrates a flowchart depicting certain processing elements of an embodiment of the image labeling system incorporating gesture recognition.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (meaning having the potential to), rather than the mandatory sense (meaning must). Similarly, the words “include”, “including”, and “includes” mean including, but not limited to.

### DETAILED DESCRIPTION OF EMBODIMENTS

Various embodiments of an image labeling system allow a user to label collections of images using gestures. In some embodiments, the image labeling system may also provide the user with visual feedback on which images are being selected and indications of how the selected images are going to be labeled. As used throughout this application, a gesture may be any input received from a user indicative of motion in two-dimensional or three-dimensional space and the gesture may be defined or further modified based on elapsed time during the gesture.

Without the use of menus or traditional input devices such as keyboards or a mouse, it can be difficult to label a large quantity of images using traditional image labeling tools. However, in some embodiments, the image labeling system overcomes this problem and operates without using menus or traditional input devices. The image labeling system allows a user to label images on a touch-screen device through the interpretation of gestures to determine which images in a collection of images are being selected and the gestures are also interpreted to determine which label to apply to the selected images.

In some embodiments, the image labeling system may be implemented on a camera or a mobile device with a camera. In such an embodiment, during the camera preview period or while reviewing previously taken images, a user may see a given image within the user interface of the image labeling system, and in response to a gesture on the touch-sensitive screen, the image may be labeled according to any of the gesture recognition commands given below.

In some embodiments, a social media website may incorporate an implementation of the image labeling system to allow a user to quickly label, or apply tags to, collections of images. In other embodiments, the image labeling system may be a stand alone application that may be downloaded and installed onto a touch-sensitive device. In other embodiments, an implementation of the image labeling system may be built into the operating system of the touch-sensitive device and may be usable to label collections of images stored on the touch-sensitive device.

Various embodiments of a system and methods for labeling a collection of images are described below. For simplicity, embodiments of the system and methods for labeling a collection of images described will be referred to collectively as an image labeling system. For example purposes, embodiments of the image labeling system will be described as a system for labeling faces in digital images. Note that the example of labeling faces in digital images is not meant to be limiting, as other embodiments of the image labeling system may assign labels to images based on image content other than faces.

In some embodiments, the image labeling system may provide a semi-automated mechanism through which a user may assign labels to all of the images in a collection of digital images. For example, the image labeling system may enable the user to label all of the image elements (e.g., faces, animals, beaches) that appear in each image of the digital image collection. A label, or a “tag,” that is assigned to a face may be a person's name or may otherwise identify the person. Labels that are assigned to faces in a digital image may be associated with the image. For example, the face labels may be included in metadata for the image. A digital image may include several faces, or various combinations of image elements, where each image element may have a different label. Accordingly, each face label may include information which identifies a particular face in the image that corresponds to the face label. For example, the face label may include coordinate information which may specify the location of the corresponding face in the digital image. Other labels that may be assigned to images via the image labeling system may identify content other than faces that is contained within the images. For example, the image labels may identify a particular event, location or scene that is contained in the content of the image. In such a case, for example, an image of a beach or a snowy or rainy backdrop or activity such as skiing, generated metadata may be associated with the entirety of the image, rather than to any particular coordinate or component element of the image.

In some embodiments, a user may apply labels to images in a digital image collection for a variety of reasons. For example, the image labels may enable efficient search and retrieval of images with particular content from a large image collection. As another example, image labels may enable efficient and accurate sorting of the images according to image content. Examples of digital images that may be included in a digital image collection may include, but are not limited to, images captured with a digital camera, photographs scanned into a computer system, and video frames extracted from a digital video sequence. A collection of digital images may be a set of digital photographs organized as a digital photo album, a set of video frames which represent a digital video sequence, or any set of digital images which are organized or grouped together. Digital images may also be visual representations of other types of electronic items. For example, the digital images may be visual representations of electronic documents, such as word processing documents, spreadsheets, and/or portable document format (PDF) files. The image labeling system may be operable to enable a user to label a collection of any sort of electronic items which may be visually represented.

In some embodiments, the image labeling system may provide a semi-automatic mechanism through which a user may efficiently assign labels to all of the images in a set of images. The system, via a display in a display area, may automatically display unlabeled image elements that are likely to be similar to displayed, labeled image elements. The image labeling system may indicate a likelihood of similarity between an unlabeled image element and a labeled image element via the spatial proximity of the unlabeled image element to the labeled image element. For example, an unlabeled image element that is more likely to be similar to a labeled image element may be displayed closer, in spatial proximity, to the labeled image element. A user may provide a manual input which may indicate labels for the unlabeled image elements.

In some embodiments, the image labeling system may maintain the same context (e.g., a same view in a same display area) as image elements are labeled. The display of unlabeled image elements in the display area may be continuously updated as a user labels image elements, but the context of the display area may not be changed throughout the image element labeling process. Accordingly, the user does not have to lose context or navigate through multiple windows while labeling a set of images.

In some embodiments, the image labeling system may analyze image content to determine image elements that are likely to be similar. The system may occasionally make mistakes when determining similar image elements, due to obscured content, poor quality images, or for other reasons. However, any mistakes that the image labeling system makes may be unobtrusive to the user. For example, a user may simply ignore unlabeled image elements in a display area that do not match any of the labeled image elements in the display area. The non-matched unlabeled image elements may eventually be removed from the display area as the image labeling system continuously updates the display of unlabeled image elements in response to labels that are received from the user. For example, as a user labels images, the image recognition engine may recalculate the similarity of an unlabeled image with a higher degree of confidence, and if the unlabeled image has become increasingly dissimilar, it may eventually fall beneath the threshold at which images are chosen for display within the user interface labeling area.

In some embodiments, the user input which indicates labels for unlabeled images may serve two purposes for the image labeling system. The user input may enable the image labeling system to assign labels to unlabeled images in order to meet the goal of the system to label all of the images in a set of images. Furthermore, the user input may serve as training information which may assist the image labeling system in making more accurate estimations of similar image elements. The image labeling system may use the user-assigned labels as additional criteria when comparing image elements to determine whether the image elements are similar. The image labeling system may continuously receive training feedback as a user applies labels to images and may use the training feedback to increase the accuracy of determining similar image elements. Accordingly, the accuracy of the display of the unlabeled image elements may be increasingly improved as the image element labeling process progresses, which may, in turn, increase efficiencies for the user of the system.

Various embodiments of a system and method for labeling a collection of images are described. In the following detailed description, numerous specific details are set forth to provide a thorough understanding of claimed subject matter. However, it will be understood by those skilled in the art that claimed subject matter may be practiced without these specific details. In other instances, methods, apparatus or systems that would be known by one of ordinary skill have not been described in detail so as not to obscure claimed subject matter.

Some portions of the detailed description may be presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Image Labeling Module

In some embodiments, the image labeling system may analyze a collection of digital images to detect all image elements that appear in each image of the collection and may provide a mechanism for a user to assign labels to each one of the detected image elements. For example, a single image may include multiple people, and in such a case, a single image element may correspond to a single face within the image.

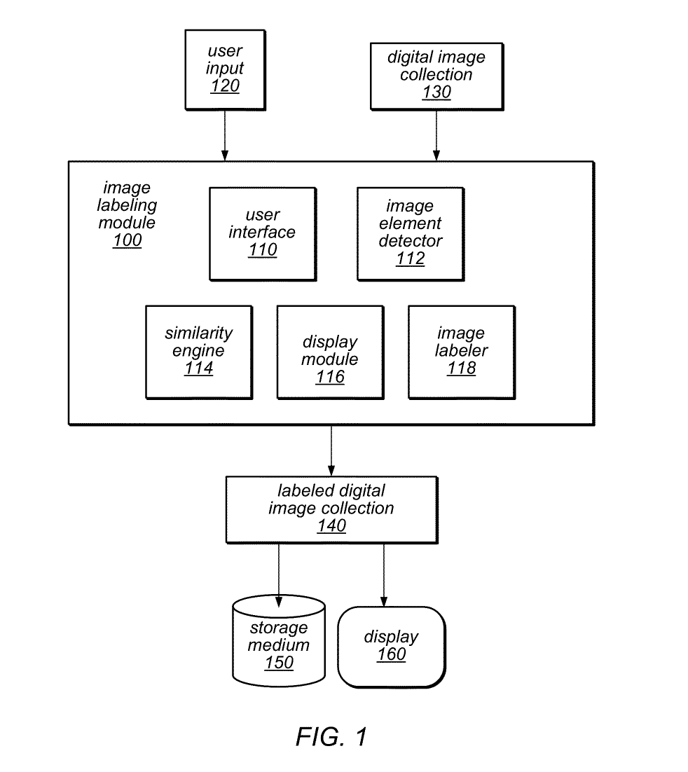

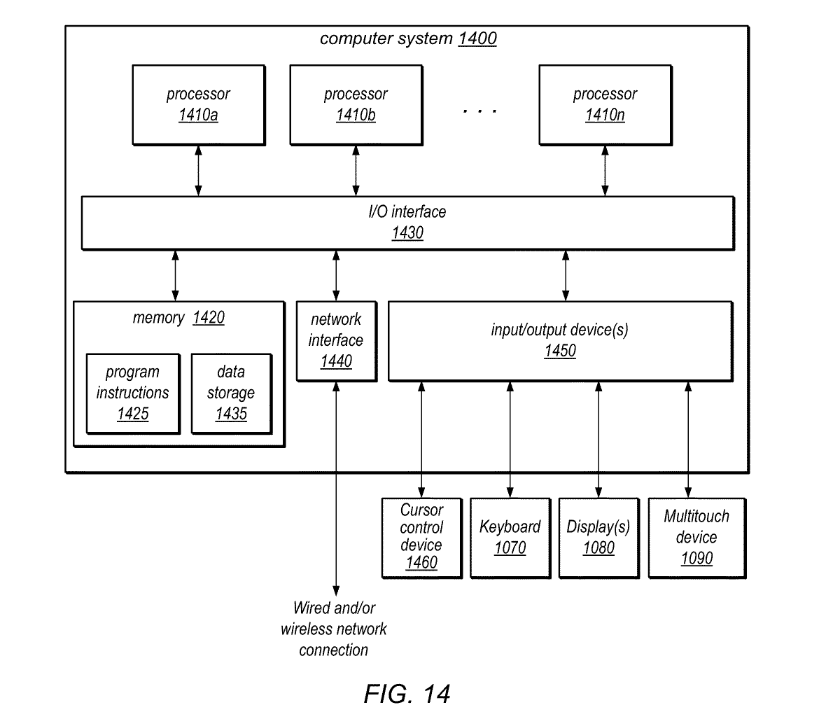

Embodiments of the method for labeling detected image elements in a collection of digital images may be implemented, for example, in an image labeling module 100, as depicted within FIG. 1. As an example, the image elements that may be detected in a collection of digital images and labeled according to the image labeling system may be a set of faces. An example image labeling module is illustrated in FIG. 1. An example system on which embodiments of an image labeling module may be implemented and executed is illustrated in FIG. 14, described in further detail below. Image labeling module 100 (or, simply, module 100) may be implemented as or in a stand-alone application or as a module of or plug-in for an image processing and/or image management application, e.g., for managing a digital photograph collection or archive. Examples of types of applications in which embodiments of module 100 may be implemented may include, but are not limited to, image analysis and editing, processing, and/or presentation applications, as well as applications in security or defense, educational, scientific, medical, publishing, digital photography, digital films, games, animation, marketing, and/or other applications in which digital image analysis, editing or presentation may be performed. Specific examples of applications in which embodiments may be implemented include, but are not limited to, Adobe® Photoshop®, Adobe® Photoshop Elements®, Adobe® Premier Elements® and Adobe® Lightroom®. Image labeling module 100 may also be used to display, manipulate, modify, classify, and/or store images, for example to a memory medium such as a storage device or storage medium.

Image labeling module 100 may receive as input a collection of digital images, such as digital image collection 130 illustrated in FIG. 1. Digital image collection 130 may be a collection of digital images (e.g. photographs) grouped, for example, as a digital photo album. Examples of digital images may include, but are not limited to Joint Photographic Experts Group (JPEG) files, Graphics Interchange Format (GIF) files, Tagged Image File Format (TIFF) files, or Portable Network Graphics (PNG) files. In other embodiments, digital image collection 130 may be a collection of visual representations of other types of electronic files, such as word processing documents, spreadsheets, and/or PDF documents. In some embodiments, the images of digital image collection 130 may include various image elements which a user may wish to identify with a label assignment for each image element. The image elements may be various types of image content. For example, the image elements may be faces of people that appear in the digital images. As another example, the image elements may be image content such as a particular event, location and/or scene.

Image element detector 112 of module 100 may analyze digital image collection 130 to detect all of the image elements that appear in the images of digital image collection 130. As an example, image element detector 112 may be a face detector. The face detector may, in various embodiments, use various algorithms to detect the faces which appear in digital image collection 130. Such algorithms may include, for example, facial pattern recognition as implemented in algorithms such as Eigenfaces, Adaboost classifier training algorithms, and neural network-based face detection algorithms. In other embodiments, the image labeling system may be operable to detect image content other than, or in addition to, faces. For example, the image labeling system may be operable to detect content such as a particular scene or location in a collection of digital images.

Similarity engine 114 of module 100 may analyze the set of image elements detected with image element detector 112 to locate image elements that are likely to be the same image content. As an example, similarity engine 114 may be a face recognition engine that may analyze a set of faces detected in digital image collection 130. The face recognition engine may determine faces that are likely to belong to the same person. The face recognition engine may compare the facial characteristics for each pair of faces in the set of detected faces.

In addition to facial characteristics, the face recognition engine may compare visual and non-visual, contextual characteristics that are associated with faces in the set of detected faces. Examples of such visual and non-visual, contextual characteristics may be clothing features, hair features, image labels, and/or image time stamps. A label that is assigned to a face may indicate particular traits that may be useful in determining whether two faces belong to the same person. For example, a label that is assigned to a face may indicate a gender, race and/or age of the person representative of the face. Dependent on the facial characteristics and/or the contextual characteristics, the face recognition engine may compute a similarity metric for each pair of faces. The similarity metric may be a value which indicates a probability that the pair of faces belong to the same person. Similarity engine 114 may be configured to analyze other types of detected image elements (e.g., landscapes) to determine similar characteristics between the detected image elements. Dependent on the analysis, similarity engine 114 may calculate a similarity metric for each pair of detected image elements.

Depending on the similarity metrics calculated according to similarity engine 114, image labeling module 100 may display a subset of the image elements to a user. For example, display module 116 may select, dependent on the similarity metrics calculated according to similarity engine 114, a subset of the detected image elements to display for a user. The image elements may be displayed, for example, in user interface 110. Display module 116 may display, in user interface 110, for example, a combination of image elements which have labels (e.g., labeled image elements) and faces which do not have labels (e.g., unlabeled image elements).

Display module 116 may determine a display location, within user interface 110, for each unlabeled image element dependent on similarity metrics between the displayed, unlabeled image elements and the displayed, labeled image elements. For example, as described in further detail below, the spatial proximity of each displayed, unlabeled image element to a displayed, labeled image element may indicate the probability that the two image elements contain the same content. As an example, image labeling module 100 may display labeled and unlabeled faces in user interface 110. The spatial proximity of the unlabeled faces to the labeled faces in the display area of user interface 110 may indicate the probability that the unlabeled and labeled faces belong to the same person.

User interface 110 may provide a mechanism which a user may use to indicate image elements which contain the same content. User interface 110 may provide one or more textual and/or graphical user interface elements, modes or techniques via which a user may interact with module 100, for example to specify, select, or change the value for one or more labels identifying one or more image elements in digital image collection 130. For example, using a selection mechanism provided from user interface 110, a user, via user input 120, may indicate unlabeled faces that belong to the same person as a labeled face.

The image labeling system may be used with any type of computing input device via which a user may select displayed image elements and assign and/or change labels for displayed image elements. For example, the image labeling system may include a conventional input pointing device, such as a mouse. As another example, the image labeling system may include a stylus input applied to a tablet PC. As yet another example, the image labeling system may include a touch-sensitive device configured to interpret touch gestures that are applied to the surface of the touch-sensitive device. As an alternative, the image labeling system may include an input device that is configured to sense gestural motions in two-dimensional or three-dimensional space. An example of such an input device may be a surface that is configured to sense non-contact gestures that are performed while hovering over the surface, rather than directly contacting the surface. User interface 110 may provide various selection tools, for example, a rectangular selection box, a brush tool, and/or a lasso tool, via which a user may use any of the input mechanisms described above to select one or more images displayed in user interface 110.

Dependent on the user input, image labeling module 100 may assign labels to the unlabeled image elements selected, or indicated, through the user via user input 120. For example, image labeler 118 may assign labels to unlabeled image elements, dependent on the user input. As an example, image labeler 118 may assign labels to unlabeled faces, dependent on the user input. In some embodiments, the labels may be tags assigned to the images in which the labeled image elements are depicted. The labels may be stored in association with the images, for example, as part of the image metadata. Module 100 may generate as output a labeled digital image collection 140, with each face, or other image content, in the collection associated with a label. Labeled digital image collection 140 may, for example, be stored to a storage medium 150, such as system memory, a disk drive, DVD, CD, etc., and/or displayed on a display 160.

### Labeling Image Elements

The images of digital image collection 130 may include various image elements which a user may wish to identify with labels. For example, digital image collection 130 may include images of various people which a user may wish to identify with a label assignment for each person. Labeling each person that appears in digital image collection 130 may allow a user to perform future searches to locate a particular person or persons within the digital image collection. For example, a user may wish to perform a search of the digital image collection in order to locate all images which contain a person labeled as “Ellen.” Since facial characteristics may be a convenient mechanism for recognizing a person in an image, people in digital images may be identified according to their faces. Similarly, a label which identifies a person in a digital image may be associated with the person's face in the image. Accordingly, the labels referred to herein may be labels associated with faces in a collection of digital images. A label associated with a face in a digital image may typically be the name of the person in the digital image, although other types of labels are possible. For example, a label may be a description that identifies a person as part of a particular group (e.g., “family” or “classmate”).

As described above, image labeling module 100 may receive a digital image collection 130. Image element detector 112 may perform an analysis of the images in digital image collection 130 to detect all of the faces that appear in digital image collection 130. To detect faces that appear in a digital image, image element detector 112 may identify regions or portions of the digital image that may correspond to a face depicted in the digital image. In various embodiments, various techniques may be used by image element detector 112 to identify such regions or portions of a digital image that may correspond to a face. Some example techniques that may be employed by image element detector 112 may include, but are not limited to, facial patterns defined according to Eigenfaces, Adaboost classifier training algorithms, and neural network-based face detection algorithms.

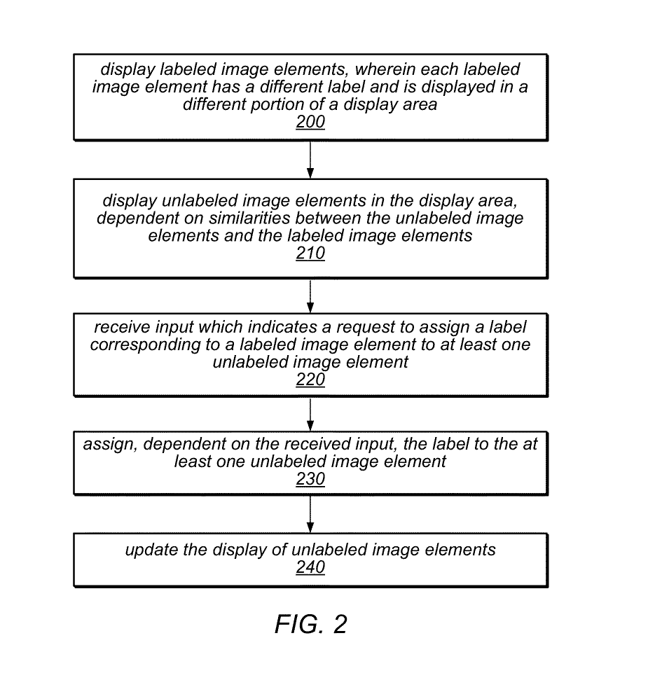

Image labeling module 100 may implement the method illustrated in FIG. 2 to label each image element (e.g., each face) that is detected in digital image collection 130. As indicated at 200, the method illustrated in FIG. 2 may include displaying labeled image elements, wherein each labeled image element has a different label and is displayed in a different portion of a display area. For example, face display module 116 may display, in user interface 110, image elements which are a subset of the faces detected in digital image collection 130. Each face in the subset of faces that is displayed in user interface 110 may have a label that has been assigned according to user input. Each of the displayed faces may have a different label (e.g., may be a different person) and may be displayed in a different portion of the display area in user interface 110.

The labeled faces that are displayed according to face display module 116 may be a subset of the detected faces in digital image collection 130. A user, via user interface 110 of module 100, may assign labels to the subset of the faces in digital image collection 130. The initial user input which assigns labels to a subset of faces in the digital image collection may provide an initial set of labeled faces which the image labeling system may use to begin the image labeling process. In some embodiments, the user may select a desired number of the detected faces and may provide user input which may assign a label to each face selected according to user input. In other embodiments, image labeling module 100 may provide guidance, and/or instructions, to the user for labeling a subset of the detected faces. For example, image labeling module 100, via user interface 110, may instruct the user to select and label a certain number of the detected faces in digital image collection 130. In such an example, image labeling module 100 may request that the user assign labels to a particular number, or a particular percentage, of the detected faces in digital image collection 130.

In other embodiments, image labeling module 100 may select a subset of the faces detected in digital image collection 130 and may request that the user assign a label to each face in the selected subset of faces. Similarity engine 114 may calculate a similarity metric for each pair of detected faces in digital image collection 130. The similarity metric for a pair of faces may correspond to a measure of similarity between the faces. In some embodiments, image labeling module 100 may select the initial subset of faces to be labeled according to a user dependent on the similarity metrics calculated from similarity engine 114. For example, dependent on the similarity metrics, similarity engine 114 may form groups of similar faces. From each group of similar faces, similarity engine 114 may select a representative image. Image labeling module 100 may display some, or all, of the representative faces to the user and may request that the user assign a label to each one of the representative faces. Some or all of the faces which have been labeled according to user input may be displayed with image labeling module 100 in user interface 110.

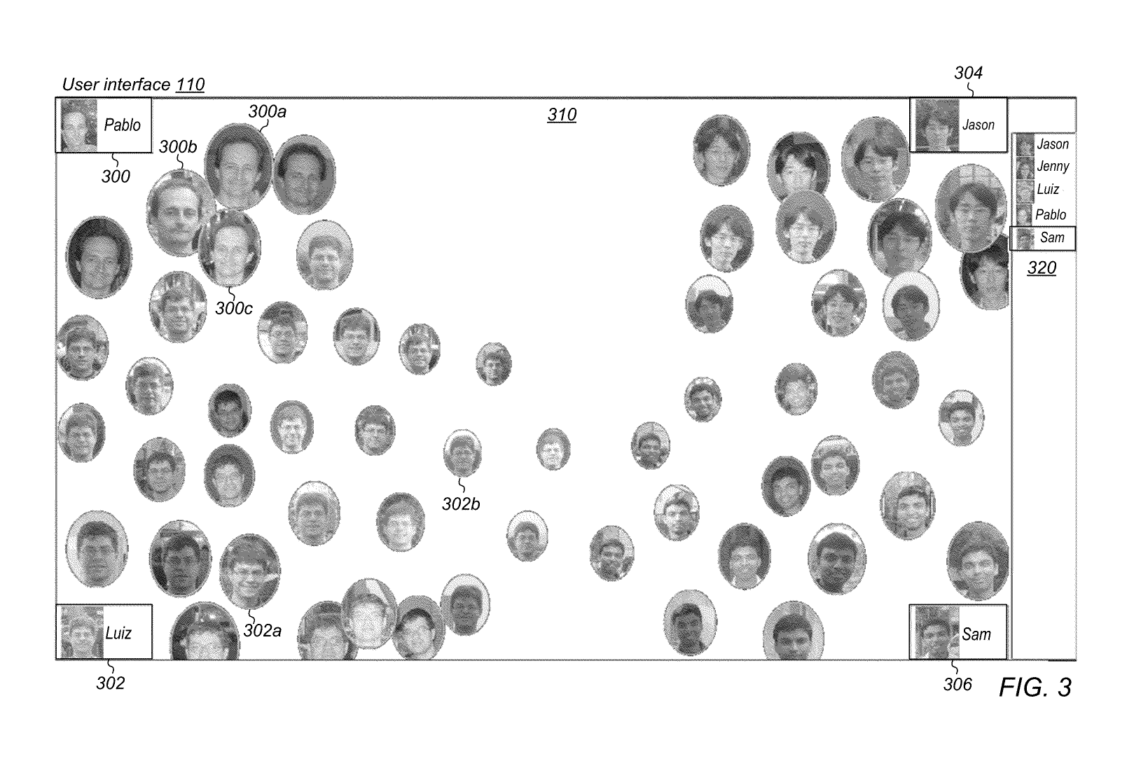

An example of labeled faces that may be displayed in user interface 110 is illustrated in FIG. 3. As shown in FIG. 3, multiple labeled faces may be displayed in different portions of the user interface. For example, region 310 of FIG. 3 illustrates four faces, 300, 302, 304 and 306, which have different labels. In FIG. 3, each one of the labeled faces, 300-306, is displayed in a different corner of the rectangular display region 310 of user interface 110. Note that FIG. 3 merely illustrates an example of one type of user interface which may be used in some embodiments to display labeled image elements (e.g., faces) in different regions of a display area.

Other embodiments may display a different number of labeled image elements, may use different portions of a display region, and/or may use a display region of a different shape. For example, instead of displaying four different labeled faces in the four corners of a rectangular display area, as illustrated in region 310 of FIG. 3, other embodiments may display a number of different labeled faces in different regions of a circular display area. In yet another example, a user, via user input 120, may determine how many labeled faces to display, and may determine where to display each labeled face in the display area. Various options may exist for displaying a number of labeled image elements in a display area. The labeled image elements may be displayed in any configuration such that a suitable amount of visual separation exists between the different labeled image elements. As described in further detail below, the displayed, labeled image elements may serve as a baseline set of image elements that may be used to indicate labels for unlabeled image elements.

In some embodiments, image labeling module 100 may automatically select the labeled faces that are displayed in a display region. As an example, image labeling module 100 may arbitrarily select four faces from the subset of labeled faces for display in region 310. As another example, image labeling module 100 may display a number of representative images from groups of similar images that have been formed dependent on the similarity metrics, as described above. In other embodiments, a user may select the labeled faces which may be displayed in region 310 of user interface 110. As an example, FIG. 3 illustrates, in column 320, a set of faces that have been labeled according to user input. The set of faces displayed in column 320 may be all of the faces that have been labeled according to user input or may be a subset of the faces that have been labeled according to user input. The user may select, from the faces displayed in column 320, one or more faces to be displayed in region 310. For example, the user may select a face in column 320 and may then drag the face into region 310.

The image labeling system, in various embodiments, may use a variety of different methods to detect image elements in digital images. The image labeling system, in various embodiments, may also use a variety of different methods to determine similarities between image elements and calculate similarity metrics for pairs of image elements. As an example, image element detector 112 and similarity engine 114 may detect faces and calculate similarity metrics for pairs of the detected faces using a method similar that described in U.S. patent application Ser. No. 12/857,351 entitled “System and Method for Using Contextual Features to Improve Face Recognition in Digital Images,” filed Aug. 16, 2010, the content of which is incorporated by reference herein in its entirety.

As indicated at 210, the method illustrated in FIG. 2 may include displaying unlabeled image elements in the display area, dependent on similarities between the unlabeled image elements and the labeled image elements. As an example, display module 116 may display a number of unlabeled faces in region 310 of user interface 110. FIG. 3 illustrates an example of one or more unlabeled faces that are displayed in region 310 of user interface 110. The faces displayed as sphere-shaped thumbnails in display region 310 of FIG. 3 are examples of displayed, unlabeled faces. The display position of each unlabeled face within region 310 may be dependent on the similarity of the unlabeled face to the displayed, labeled faces.

Face display module 116 may display up to a maximum number of unlabeled faces, M, in display region 310. The maximum number of faces, M, may be determined such that the display area is not cluttered with too many unlabeled faces. For example, display module 116 may calculate M, based on the size of display region 310, such that a certain amount of open space remains in display region 310 when M unlabeled faces are displayed in display region 310. In other embodiments, a number of maximum faces, M, may be selected according to user input, for example, via an options or preferences menu within user interface 110.

Face display module 116 may select up to M unlabeled faces from the set of unlabeled faces for display in display region 310. The selection of up to M unlabeled face may be dependent on the displayed, labeled faces and may also be dependent on the similarity metrics calculated from similarity engine 114. Face display module 116 may use the similarity metrics to determine the M unlabeled faces that are most similar to the displayed, labeled faces. For example, in reference to FIG. 3, face display module 116 may determine, dependent on the similarity metrics, the M unlabeled faces that are most similar to faces 300-306. As illustrated in FIG. 3, face display module 116 may display the M unlabeled faces that are most similar to the labeled faces in display region 310.

The display position of an unlabeled face may be dependent on the similarities (e.g., the similarity metrics) between the unlabeled face and the displayed, labeled faces. More specifically, as described in further detail below, the spatial proximity of an unlabeled face in display region 310 to a labeled face in display region 310 may indicate the likelihood that the two faces belong to the same person. For example, an unlabeled face and a labeled face that are displayed in close spatial proximity are very likely to be faces that belong to the same person. FIG. 3 illustrates an example of a display of unlabeled faces which indicates, via spatial proximity, faces that are likely to belong to the same person. For example, unlabeled faces 300a, 300b and 300c in FIG. 3 are displayed in close spatial proximity to labeled face 300 because the image labeling system has determined that the faces are likely to belong to the same person.

In some embodiments, the display size of an unlabeled face may also be dependent on the similarities (e.g., the similarity metrics) between the unlabeled face and the displayed, labeled faces. For example, the display size of an unlabeled face may indicate that likelihood that the unlabeled face belongs to the same person as a labeled face. For example, an unlabeled face that is more likely to be the same person as a labeled face may be displayed in a larger size than an unlabeled face that is less likely to be the same person as a labeled face. FIG. 3 illustrates an example of unlabeled faces with different display sizes. For example, note that unlabeled face 302a in FIG. 3 has a larger display size than unlabeled face 302b in FIG. 3. The image labeling system has determined that unlabeled face 302b is less likely than unlabeled face 302a to be the same person as labeled face 302. Accordingly, unlabeled face 302b is displayed with a smaller size than unlabeled face 302a in FIG. 3.

In other embodiments, the image labeling system may use other criteria to select and display unlabeled images in the display area. As an example, the image labeling system may place male faces on one side of the display area and female faces on the other side of the display area. As another example, the image labeling system may place faces in the display area based on criteria such as race or age. In yet another example, the image labeling system may place faces in the display area based on time and/or location (e.g., geo-tag) information for the images which depict the faces. The criteria for placing unlabeled images in a display area may be determined according to user input via user interface 110. For example, the user may wish to label all of the faces of people who attended a particular party or event. The image labeling system may use a image labeling method similar to that described above for a particular set of images which have timestamps within a specified time period, for example, a range of time over which the particular party or event took place.

As indicated at 220, the method illustrated in FIG. 2 may include receiving input which indicates a request to assign a label corresponding to a labeled image element to at least one of the unlabeled image elements. For example, a user may provide input which selects one of the labeled image elements in a display region. The user may then provide input which selects one or more of the unlabeled image elements in the display region. The user's selection of the one or more unlabeled image elements may indicate that the label for the selected, labeled image element may be applied to the selected one or more unlabeled image elements. A user may select the one or more unlabeled image elements via a variety of different user input mechanisms provided through user interface 110. For example, the user may drag a rectangular selection region over one or more unlabeled image elements to select the unlabeled image elements. As another example, the user may use a brush tool, a lasso tool, or other similar tool to indicate selected unlabeled image elements. As described above, the user selection may be via an input pointing device, such as a mouse, or in response to a gesture applied to, or close to, a touch-sensitive screen. In some embodiments, a user is not required to select one or more of the labeled images prior to selecting unlabeled images to be associated with the labeled image. A user may select one or more unlabeled images and subsequently indicate/select a labeled image with which the unlabeled images/faces are to be associated. For example, a user may simply select one or more unlabeled images and drag the unlabeled image into a region proximate to one or more labeled images to associate the unlabeled images with the labeled image. The unlabeled images may be associated with one or more labeled images upon commitment of the unlabeled images to a region (e.g., mouse-up at the end of a user drag-and-drop operation) and/or the unlabeled images may be associated with one more labeled images nearest to the location where the one or more unlabeled images are dragged to. For example, after selecting one or more unlabeled images (e.g., via a rectangle, brush or lasso selection tool), a user may simply drag the unlabeled images into a display region (e.g., destination position) closer (e.g., nearer in spatial proximity) to a first labeled image than to another labeled image, the destination position may be determined upon mouse-up of the drag-and-drop operation, it may be determined that the unlabeled images are nearest the first labeled image based on the destination position, and the unlabeled images may be commonly labeled with (or otherwise associated with) the first labeled image. Although several embodiments described herein refer to a selection of one or more labeled images/faces prior to selection of one or more unlabeled images/faces to be associated with the labeled image/face, it will be appreciated that alternative embodiments to those described may employ the above described technique in which a user is able to select one or more unlabeled images/faces and subsequently indicate/select one or more labeled images/faces with which the unlabeled images/faces are to be associated. In some embodiments, the user may have the option on use either of these and other selection techniques. The user interface which a user may use to select labeled and/or unlabeled images may be implemented in a variety of different ways and the examples provided herein are not meant to be limiting.

As a specific example, a user may select a labeled face in display region. Subsequent to the selection of the labeled face, the user may further select one or more unlabeled faces in the display region. The user selection of the one or more unlabeled faces may indicate that the label for the selected face should be applied to the selected one or more unlabeled faces. In some embodiments, a user may select a labeled face in a corner and may select one or more unlabeled faces which should receive the same label through the process of “painting over” the unlabeled faces. The image labeling system may provide various mechanisms and/or tools via which a user may select a group of unlabeled faces. For example, a user may use a rectangle selection tool, a brush tool, and/or a lasso tool to select the one or more unlabeled faces.

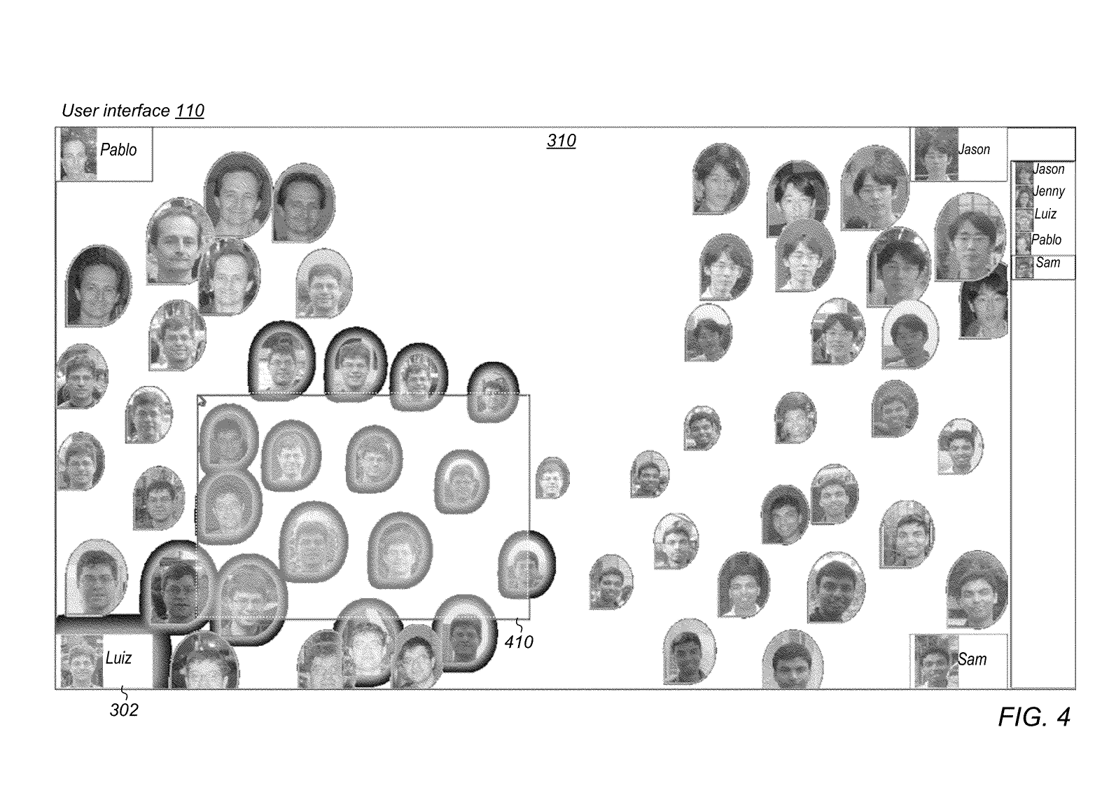

FIG. 4 illustrates an example of user selection of one or more unlabeled image elements using a rectangle selection tool. Specifically, FIG. 4 illustrates a user selection of one or more unlabeled faces using a rectangle selection tool. As illustrated in FIG. 4, a user may select a labeled face, for example, face 302. The user may then, using a rectangle selection tool, select one or more unlabeled faces through an indication of a rectangular selection region, such as region 410 illustrated in FIG. 4. The user selection of the unlabeled faces in region 410 may indicate a request to assign the label of face 302 to the unlabeled faces in region 410. More specifically, the user selection of the unlabeled faces in region 410 may indicate that the unlabeled faces in region 410 belong to the same person as face 302. Unlabeled faces that are at least partially included in the rectangular selection region may be selected. As an alternative embodiment, only unlabeled faces that are entirely included in the rectangular selection region may be selected. Further, on a touch-sensitive device, the rectangle selection tool may be enabled through the use of a stylus or finger touch in combination with a user setting defining default behavior when a touch down and drag operation is performed to correspond to a rectangle selection, instead of, for example, path selection as described below.

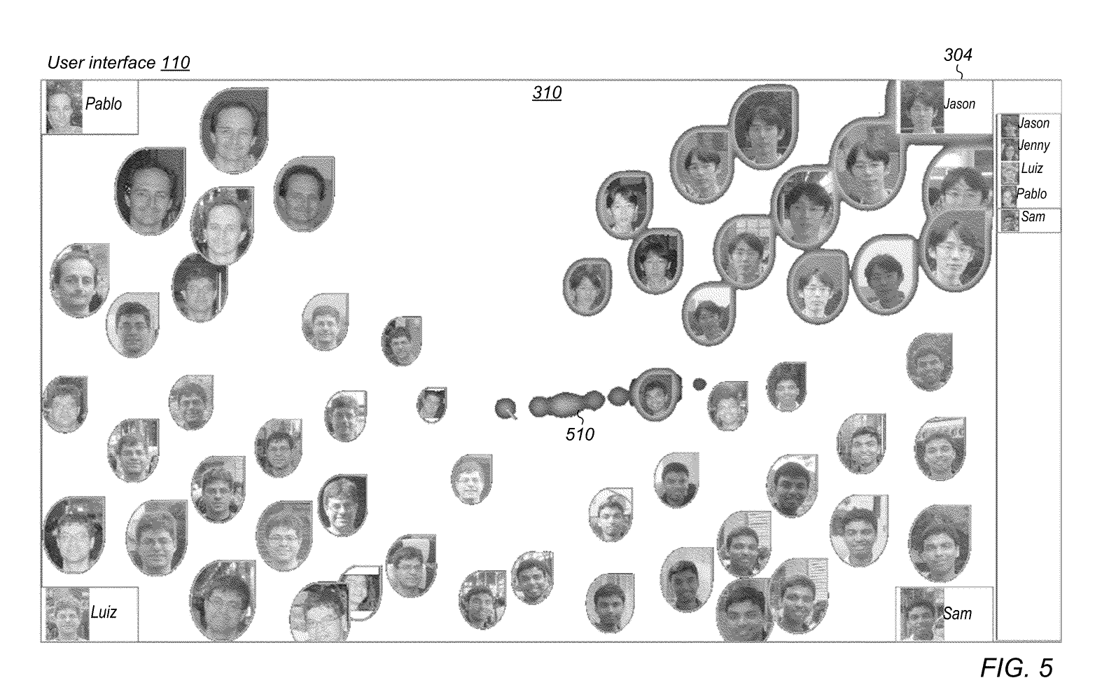

FIG. 5 illustrates an example of user selection of one or more unlabeled image elements using a brush selection tool. Specifically, FIG. 5 illustrates a user selection of one or more unlabeled faces using a brush selection tool. As illustrated in FIG. 5, a user may select a labeled face, for example, face 304. The user may then, using a brush selection tool, select one or more unlabeled faces based on painting a brush stroke, such as brush stroke 510 in FIG. 5, across the unlabeled faces that the user wishes to select. The user selection of the unlabeled faces via brush stroke 510 may indicate a request to assign the label of face 304 to the unlabeled faces selected via brush stroke 510. Unlabeled faces that at least partially touch the brush stroke of the user may also be selected.

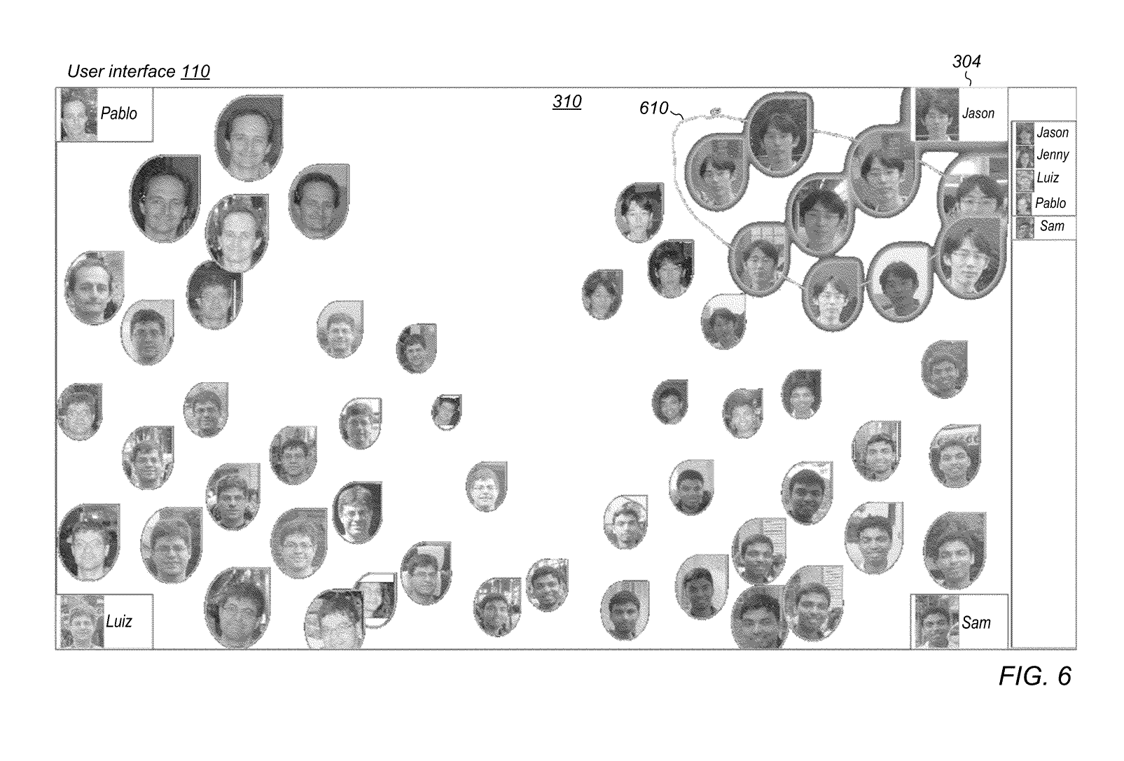

FIG. 6 illustrates an example of user selection of one or more unlabeled image elements using a lasso selection tool. Specifically, FIG. 6 illustrates a user selection of one or more unlabeled faces using a lasso selection tool. As illustrated in FIG. 6, a user may select a labeled face, for example, face 304. The user may then, using a lasso selection tool, select one or more unlabeled faces based on encircling the one or more unlabeled faces with a lasso, such as lasso 610 illustrated in FIG. 6. The user selection of the unlabeled faces encircled with lasso 610 may indicate a request to assign the label of face 304 to the unlabeled faces encircled with lasso 610. Unlabeled faces that are at least partially encircled with the lasso may be selected. As an alternative embodiment, only unlabeled faces that are entirely encircled with the lasso may be selected.

Note that the examples of selecting one or more unlabeled faces via a rectangle selection tool, a brush selection tool, and a lasso selection are provided merely as examples and are not meant to be limiting. User interface 110 may provide a variety of mechanisms through which a user may select unlabeled faces. For example, a user may simply select the unlabeled faces based on clicking on the display of each unlabeled face. Further note that, in some embodiments, the user may directly select the labeled face before selecting the one or more unlabeled images, as described above. As an alternative embodiment, the labeled face may be automatically selected in response to the user selection of one or more unlabeled faces. For example, a labeled face which corresponds to (e.g., is most similar to) one or more selected, unlabeled faces may be automatically selected in response to the selection of the one or more unlabeled faces.

Receiving user input which indicates labels to be assigned to image elements in a collection of images may enable the image labeling system to 1) apply labels to the image elements and 2) receive training input which may allow the image labeling system to more accurately calculate similarity metrics between pairs of faces within the collection of images. The labels that are assigned to image elements may indicate additional characteristics for the image elements. For example, a label that is assigned to a face may indicate a gender, race, and/or age for the face. Accordingly, the image labeling system may use the assigned labels to more accurately determine similar faces in a set of detected faces. As described in further detail below, the image labeling system may use the user-assigned labels to recalculate similarity metrics for pairs of image elements in the collection of images. Since the recalculated similarity metrics may have the benefit of additional data (e.g., the newly applied labels), the recalculated similarity metrics may more accurately represent the similarities between pairs of faces.

As indicated at 230, the method illustrated in FIG. 2 may include assigning, dependent on the received input, the label to the at least one unlabeled image element. As described above, the user selection of the at least one unlabeled image element may indicate a request to assign a particular label (e.g., the label of a selected, labeled image element) to the selected at least one unlabeled image element. For example, as described above and as illustrated in FIGS. 4-6, a user may select a labeled face in a display region and may select at least one unlabeled face to which the label of the labeled face may be applied. In response to the user input which selects the at least one unlabeled face, image labeler 118 may assign the label to the at least one unlabeled face. Labels that are assigned to faces in a digital image may be associated with the image. For example, the face labels may be included in metadata for the image. A digital image may include several faces, each of which may have a different label. Accordingly, each face label may include information which identifies a particular face in the image that corresponds to the face label. For example, the face label may include coordinate information which may specify the location of the corresponding face in the digital image.

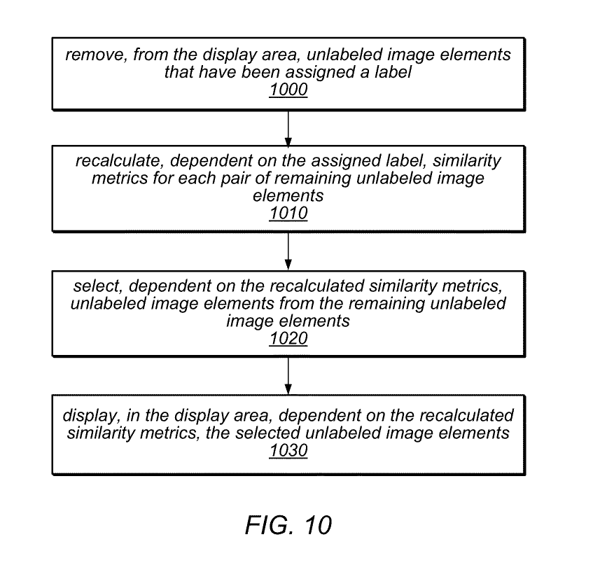

As indicated at 240, the method illustrated in FIG. 2 may include updating the display of unlabeled image elements. As described in further detail below, in reference to FIG. 10, display module 116 may, in response to the received input, display an updated set of unlabeled image elements. Display module 116 may remove the newly labeled image elements from the display area. Display module 116 may select a new set of unlabeled image elements for display in the display area and may display the new set of unlabeled image elements in the display area. As described in further detail below, the new set of unlabeled image elements may include any combination of previously displayed unlabeled image elements and unlabeled image elements that have not yet been displayed. Display module 116 may maintain up to a maximum number, M, of unlabeled image elements in the display area.

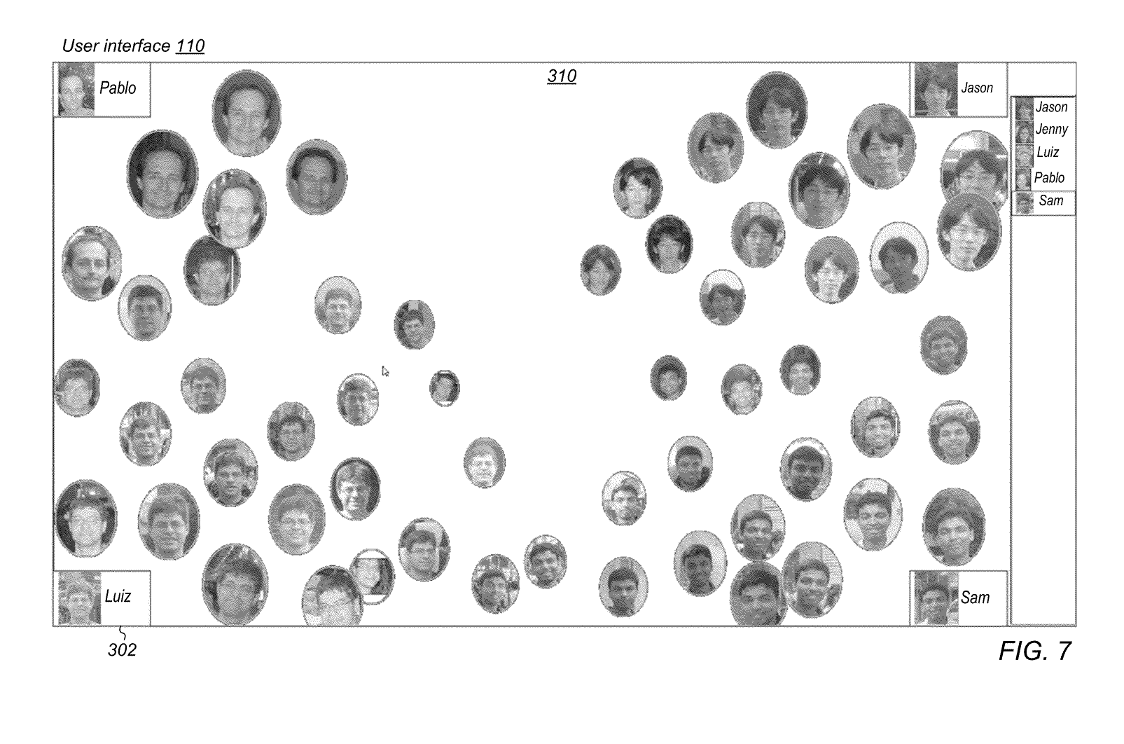

FIG. 7 illustrates an example of a display of unlabeled image elements that has been updated after receiving user input which indicates labels for one or more unlabeled image elements. More specifically, FIG. 7 illustrates an example of a display of unlabeled faces that has been updated in response to user selection which indicates labels for one or more unlabeled image elements. As shown in FIG. 7, a new set of unlabeled faces which are similar to face 302 have been displayed. The new set of unlabeled faces may be displayed in FIG. 7 in response to the user input of FIG. 4. More specifically, the user input illustrated in FIG. 7 indicates, via a rectangular selection region 310, a set of unlabeled faces that should receive the same label as face 302. The selected, unlabeled faces may be labeled according to the user input, removed from the display region in FIG. 7, and replaced with a new set of unlabeled faces, as illustrated in FIG. 7.

The image labeling system may, as described in further detail below, recalculate similarity metrics for each pair of unlabeled image elements. The recalculated similarity metrics may be dependent on the newly assigned labels, and, thus may be more accurate than the previously calculated similarity metrics. The image labeling system may select the new set of unlabeled image elements for display dependent on the recalculated similarity metrics. Accordingly, the updated set of unlabeled image elements that is displayed may be more accurate matches to displayed labeled faces than a previous displayed set of unlabeled image elements.

The image labeling system may repeat blocks 200 through 240 of FIG. 2 until all detected image elements in digital collection 130 have been assigned a label. During the repeated execution of the image labeling process, all of the unlabeled image elements in the set of detected image elements which are similar to a particular labeled image element may be found and labeled. In such a case, if additional image elements in the set of detected image elements remain to be labeled, a new labeled image element may be selected for display in the display area. As an example, the system may provide an indication to the user that all image elements which are similar to a labeled image element have been labeled. The image labeling system may remove the labeled image element from the display area and may suggest that the user select another labeled image element for the display area. In response the user may select another labeled image element, for example from the display of labeled image elements in column 320 of FIG. 3. The user may drag the selected labeled image element into the display area. In response, the image labeling system may update the display of unlabeled image elements, using a method similar to that described above for block 220 of FIG. 2.

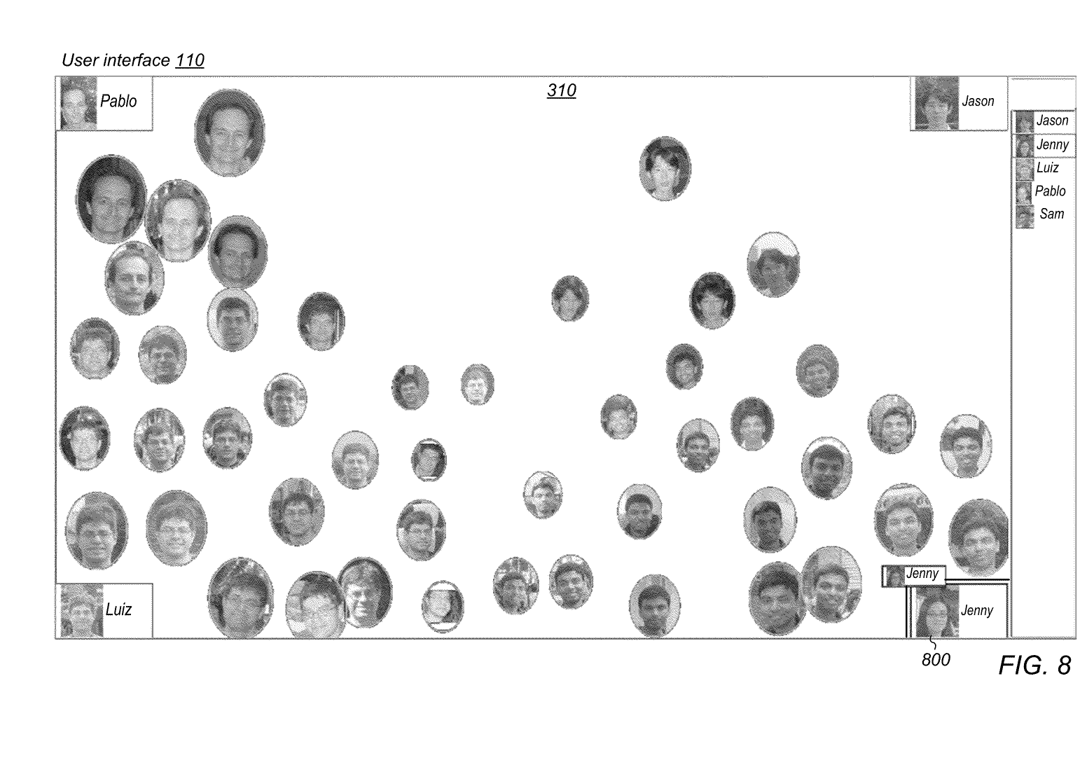

In other embodiments, the image labeling system may identify the labeled image elements which have the highest amount of similar, unlabeled image elements remaining in the set of detected image elements. The image labeling system may automatically add one or more of these identified labeled faces to the display area. As an alternative, the image labeling system may request that the user select one of the identified labeled image elements. As yet another example, at any point during the execution of the image labeling process, a user may manually replace a labeled image element in the display area with another labeled image element. The user may replace a labeled image element based on selecting a new image element, for example from column 320, and dragging the new image element to the area occupied with the existing labeled image element. In response to the user input, the image-labeling system may replace the existing labeled image element with the new labeled image element. The system may also update the display of unlabeled image elements to include FIG. 8 illustrates an example of a new labeled image element that has been selected and placed in the display area. For example, labeled face 306 illustrated in FIG. 3 has been replaced with labeled face 800 in FIG. 8. The unlabeled faces in FIG. 8 have not yet been updated to reflect the addition of new labeled face 800.

### Labeling Documents

As noted above, the image labeling system may operate to label documents, including documents that have not been rendered into images. In the case that the document includes an image, the image labeling system may operate similarly to the examples described above for images.

However, the image labeling system may also operate on documents in any native, non-image based format, such as a Microsoft™ Word™ document or any text based document or any document that may include text, and where the documents may exist in a local or network file system. In such a case, a user may initiate the image labeling system and enter a search term, for example, “January presentation.” Given such a search term, many documents may be found, including documents that may not be relevant to the January presentation the user had in mind. Within the image labeling system user interface, each of the found documents may have a corresponding preview image displayed in a location on the user interface such that the proximity of the preview image to a label area is based on the relevance determined by the search engine. In this example, a corner of the display region may be assigned a label that has yet to be associated with any particular document or image.

In some cases where there are a large number of search results, only a selection of the best matches may be displayed at a time, and more may be displayed as documents are labeled and removed from the preview area. For example, if the user has created a label area in a top left corner of the display region, the documents that the search engine has determined are most relevant are displayed in a location very near the top left corner. Similarly, documents that the search engine has determined are less relevant, yet still match the search term to some degree, are displayed in a location farther away. For example, if a document only partially matches the “January presentation” search term on the basis of including the word, “jan”, the document may be placed farther away. In this way, documents with a high degree of relevance based on the search engine results may be placed closer to a given label area, and/or displayed with a larger sized preview image.

Further, each of the image labeling system supported gestures or user input may apply similarly to labeling documents. In other words, a document may be flicked toward the label, or lassoed, selected according to a drawn path, or selected with a rectangle tool using a mouse input. Similarly, multiple labels may be used at a time, such as “January Presentation” in the top left corner and “America Invents Act” in another corner of the user interface.

In one embodiment, to assign multiple labels to a document without the document disappearing from the display region after a first label assignment, a labeled image may dragged on to the unlabeled image in the display region. In response, the unlabeled image is assigned the label corresponding to the labeled image while remaining in the display region. This process may be repeated to assign any number of labels to a given image element. To finally remove the image element from the display region, the image element may be dragged onto a labeled image, and after this assignment the image element may be removed from the display region. In addition to text-based documents, this process for assigning multiple labels to an image element works similarly with graphical, or non-text based images described throughout this application.

In the case that the image labeling system has been embedded within a network application connected to the Internet, such as a browser, an Internet search engine may be used to perform a search to retrieve documents for labeling. In such a case, the results may be presented as preview images of the web site or content site returned by the search engine. Once a user has labeled one or more of the search results, the user may then save the labeling results, for example, with the creation of a bookmark category for a set of labeled results. In the case that the search engine is directed to return image results, the user may also save a labeled set of images at a specified location or storage device, for example within a folder with a name corresponding to the label.

### Display Unlabeled Image Elements

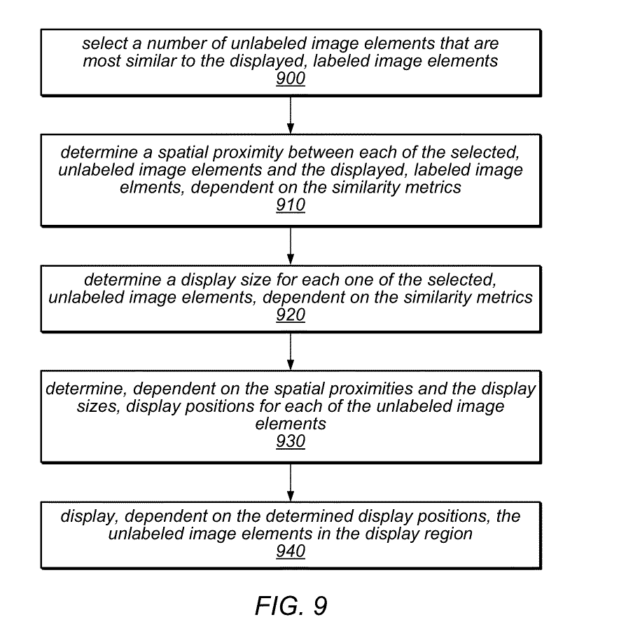

As described above, in reference to block 210 of FIG. 2, unlabeled image elements may be displayed in the display area dependent on similarities between the unlabeled image elements and labeled image elements that are displayed in the same display area. For example, the spatial proximity of the unlabeled image elements to the labeled image elements may be dependent on similarities between the unlabeled image elements and the labeled image elements. As another example, the display size of each unlabeled image element may be dependent on similarities between the unlabeled image element and a labeled image element in the same display area. A display of unlabeled image elements in a display area may contain a maximum number of image elements and the image elements may be displayed such that there is a minimum amount of overlap of the unlabeled image elements. FIG. 9 is a flowchart of a method for displaying unlabeled image elements in a display area. As an example, display module 116 may be configured to implement the method of FIG. 9 to display unlabeled faces in a display area, such as illustrated in FIG. 3.

As illustrated in FIG. 3, a display region may include a display of a number of labeled image elements (e.g., faces) which are displayed in different portions of the display region. As indicated at 900, the method illustrated in FIG. 9 may include selecting a number of unlabeled image elements that are most similar to the displayed, labeled image elements. For example, display module 116 may select, from a set of unlabeled faces, a subset of unlabeled faces that are most likely to correspond to the labeled faces displayed in a display region. As described above, and in further detail below, each pair of faces in a set of detected faces for a digital image collection may have a corresponding similarity metric. The similarity metric for a pair of faces may indicate the probability that the faces belong to the same person.

Display module 116 may retrieve a similarity metric for each possible pair of an unlabeled face and a displayed, labeled face. Display module 116 may sort the unlabeled faces dependent on the retrieved similarity metrics. More specifically, display module 116 may sort the unlabeled faces such that unlabeled faces at the top of the sorted list have the highest probability of matching the displayed, labeled faces. Display module 116 may select the top M (e.g., the maximum number of unlabeled faces) number of unlabeled faces from the sorted list for display in the display area. Accordingly, display module 116 may have a higher probability of displaying unlabeled faces that are likely to match the displayed, labeled faces.

As indicated at 910, the method illustrated in FIG. 9 may include determining a spatial proximity between each of the selected, unlabeled image elements and the displayed, labeled image elements, dependent on the similarity metrics. As an example, display module 116 of image labeling module 100 may determine a spatial proximity between each selected, unlabeled face and each displayed, labeled face. The spatial proximity for an unlabeled face may be dependent on the similarity metrics that correspond to the unlabeled face. The unlabeled face may have, for each of the displayed, labeled faces, a respective similarity metric that pairs the unlabeled face with a displayed labeled face and indicates the probability that the pair of faces belong to the same person.

Display module 116 may calculate a distance between the unlabeled face and one or more of the displayed, labeled faces, dependent on the similarity metrics for the unlabeled face and the one or more displayed, labeled faces. The calculated distance may be a spatial proximity, in the display region, between the unlabeled face and one or more displayed, labeled face. The spatial proximity, in the display region, of an unlabeled face to a labeled face may indicate a probability that the faces belong to the same person. For example, a closer spatial proximity between an unlabeled face and a labeled face indicates a higher probability that the faces belong to the same person. Locating unlabeled faces, which are a likely match to a labeled face, in close spatial proximity to the labeled face may enable a user to easily select the unlabeled faces. For example, as illustrated in FIG. 6, a user may easily, using a lasso selection tool, select unlabeled faces that are all close to labeled face 304.

In some embodiments, display module 116 may determine a spatial proximity between an unlabeled face and a displayed, labeled face that is most similar to the unlabeled face. The spatial proximity may a distance value that may be determined dependent on the similarity metric between the unlabeled face and the displayed, labeled face that is most similar to the unlabeled face. Display module 116 may use various methods to convert the similarity metric to a distance value. For example, display module 116 may linearly interpolate the similarity metric between the labeled face and the unlabeled face. The distance value may be inversely proportional to the similarity metric. For example, a higher probability similarity metric may result in a smaller distance value. From the distance value, display module 116 may determine a coordinate position, within the display region, for the unlabeled face. The determined coordinate position may specify a display position for the unlabeled face that is equivalent to the determined distance value between the unlabeled face and the labeled face. Accordingly, the spatial proximity of the unlabeled face to the labeled face may indicate the probability that the faces belong to the same person.

In other embodiments, display module 116 may determine spatial proximities between an unlabeled face and all of the displayed, labeled faces. The spatial proximities may be distance values that may be determined dependent on the similarity metrics between the unlabeled face and all of the displayed, labeled faces. For example, display module 116 may convert each similarity metric to a distance value based on a linear interpolation of the similarity metrics. Similarly as described above, each distance value may be inversely proportional to a respective similarity metric. For example, a higher probability similarity metric may result in a smaller distance value. From the distance values, display module 116 may determine a coordinate position, within the display region, for the unlabeled face. The determined coordinate position may be the coordinate position that best satisfies each of the distance values between the unlabeled face and each of the displayed, labeled faces. Accordingly, the spatial proximity of the unlabeled face to each one of the displayed, labeled faces may indicate the probability that the faces belong to the same person.

FIG. 3 illustrates an example of unlabeled faces displayed in a display area dependent on similarity metrics. As illustrated in FIG. 3, unlabeled faces are clustered towards similar labeled faces in the corners of the display area. The spatial proximity of each unlabeled face to a labeled face in FIG. 3 indicates a probability that the two faces belong to the same person. For example, unlabeled face 302a has a close spatial proximity to labeled face 302 and unlabeled face 302b has a farther spatial proximity to labeled face 302. The closer spatial proximity of unlabeled face 302a indicates that the probability that unlabeled face 302a matches labeled face 302 is higher than the probability that unlabeled face 302b matches labeled face 302.

As indicated at 920, the method illustrated in FIG. 9 may include determining a display size for each one of the selected, unlabeled image elements, dependent on the similarity metrics. As an example, display module 116 of image labeling module 100 may determine an initial display position for each selected, unlabeled face. The display size for an unlabeled face may be dependent on the similarity metrics that correspond to the unlabeled face. The unlabeled face may have, for each of the displayed, labeled faces, a respective similarity metric that pairs the unlabeled face with a displayed labeled face and indicates the probability that the pair of faces belong to the same person.

Display module 116 may calculate a display size for an unlabeled face dependent on the similarity metric between the unlabeled face and the most similar displayed, labeled face. The display size of an unlabeled face may indicate a probability that the unlabeled face and a closest displayed, labeled face belong to the same person. Display module 116 may convert the similarity metric for the unlabeled face and labeled face pair to a size scale. Display module 116 may determine the size of the display of the unlabeled face dependent on the size scale. As an example, for a similarity metric that indicates a probability above a threshold value (e.g., 70% probability that two faces belong to a same person), display module 116 may enlarge the display of the unlabeled face. As another example, for a similarity metric that indicates a probability below a threshold value (e.g., 30% probability that two faces belong to a same person), display module 116 may reduce the display of the unlabeled face. Accordingly, larger unlabeled face displays indicate higher probabilities that the unlabeled faces are a match to a corresponding displayed, labeled face.

FIG. 3 illustrates different size displays for the unlabeled faces. For example, the display size of unlabeled face 302a is larger than the display size of unlabeled face 302b. The larger display size of unlabeled face 302a indicates that the probability that unlabeled face 302a matches labeled face 302 is higher than the probability that unlabeled face 302b matches labeled face 302. As illustrated in FIG. 3, larger display sizes for unlabeled faces may indicate a higher probability that an unlabeled face is the same as a labeled face. The image labeling system may select a larger display size for unlabeled faces with higher probability of similarity to a labeled face in order to draw a user's attention to such higher probability faces.

As described above, the image labeling system may receive additional training information each time a user labels a face and, thus, may be able to provide more accurate displays of unlabeled faces. Accordingly, it may be beneficial for the image labeling system to receive user feedback (e.g., labels) on high probability faces as early as possible in the face labeling process in order to gain additional data for lower probability faces. Based on the user feedback, the system may be able to improve the probabilities of the lower probability faces, and, therefore, may be able to provide more accurate displays of unlabeled faces. Accordingly, it may be beneficial to the efficiency of the image labeling system to call a user's attention to high probability faces in order to encourage the user to provide labels for such faces early in the face labeling process.

In other embodiments, the image labeling system may use different characteristics to visually indicate similarities between labeled and unlabeled image elements. As an example, the image labeling system may use just spatial proximity to indicate similarities between labeled and unlabeled image elements. As another example, the image labeling system may use spatial proximity in addition to other characteristics that may direct a user's attention to high probability image elements. For example, the image labeling system may display high probability image elements in highlighted colors or as distinctive shapes

As indicated at 930, the method illustrated in FIG. 9 may include determining, dependent on the spatial proximities and the display sizes, display positions for each of the unlabeled image elements. The display position for each of the unlabeled image elements may be determined such that there is a minimum amount of overlap between the displays of the unlabeled image elements. Unlabeled image elements that are displayed with too much overlap may be obscured such that a user may not be able see enough of the image element to identify content in the image element. If a user cannot identify content in the unlabeled image element, the user may not be able to effectively indicate a label for the unlabeled image element.

The image labeling system may specify a maximum amount of overlap that may be acceptable for the unlabeled image elements in the display region. For example, the image labeling system may specify that a maximum of 15% of an unlabeled image element may be covered with another, overlapping unlabeled image element. The amount of maximum amount of acceptable overlap for unlabeled image elements may also be a parameter that is configurable with user input via user options or preferences in user interface 110. Display module 116 may adjust the display positions of the unlabeled image elements such that any overlap between unlabeled image elements is below the maximum specified amount of overlap. For example, display module 116 may adjust the display positions of a set of unlabeled faces to minimize overlap between the displays of the unlabeled faces.

Display module 116 may use the particle system to determine a display position for each unlabeled face such that the display of the unlabeled image elements satisfies the criteria for maximum allowable overlap between unlabeled image elements. The particle system may determine the display locations dependent on the determined display size for each of the unlabeled faces and dependent on the desired spatial proximity between the unlabeled faces and the displayed, labeled faces. As described above, distance values (e.g., spatial proximities) between each unlabeled face and each labeled face may be determined based on a linear interpolation of the similarity metrics between the unlabeled face and the displayed labeled faces. Display module 116 may use the desired distance values between unlabeled and labeled faces and the display size of each unlabeled face as inputs to the particle system. The particle system may determine a display position for each unlabeled image element that best satisfies the criteria for distance values, display size and maximum amount of overlap.

Dependent on the distance values described above, each unlabeled face may have an optimal display location in the display area. The optimal display location may position the unlabeled face in the display area such that desired spatial proximities between the unlabeled face and one or more of the unlabeled faces are optimally satisfied. The particle system may assign, to each unlabeled face, an attractive force which may act to pull the unlabeled face toward the optimal display location for the unlabeled face. The particle system may assign, to each pair of unlabeled faces, a repulsive force which may act to minimize overlap between the displays of the unlabeled faces. For example, a repulsive force between a pair of unlabeled faces may be zero if the unlabeled faces do not overlap. However, if the unlabeled faces are moved such that they begin to overlap, the strength of the repulsive force may rapidly increase. The display location of an unlabeled face may be determined from computing a display location that results in an equilibrium status between the attractive forces and repulsive forces for the unlabeled face. One example of such a particle system is described in U.S. Pat. No. 7,123,269 entitled “Creating and Manipulating Related Vector Objects in an Image,” filed Jun. 21, 2002, the content of which is incorporated by reference herein in its entirety.

As indicated at 940, the method illustrated in FIG. 9 may include displaying, dependent on the determined display positions, the unlabeled image elements in the display region. Since the display positions have been determined to minimize overlap between the unlabeled image elements, the unlabeled image elements may be displayed such that overlap between the unlabeled image elements is minimized. FIG. 3 illustrates an example of unlabeled faces that may be displayed in a display region using the above described particle system. Note that the unlabeled faces in FIG. 3 have been displayed such that only a few of the unlabeled faces are overlapping. For the unlabeled face displays that overlap, in FIG. 3, the overlap has been restricted to a maximum amount of overlap. For example, unlabeled faces 300b and 300c are displayed such that unlabeled face 300c overlaps unlabeled face 300b. However, the overlap does not obscure the identity of unlabeled face 300b.

As described above, in reference to block 240 of FIG. 2, the display of unlabeled image element may be updated subsequent to receiving user input which indicates labels for one or more of the unlabeled image elements.

FIG. 10 is a flowchart of a method for updating a display of unlabeled image elements in a display area. As indicated at 1000, the method illustrated in FIG. 10 may include removing, from the display area, unlabeled image elements that have been assigned a label. For example, subsequent to receiving user-indicated labels for one or more unlabeled faces, display module 116 may remove the newly labeled faces from the display area. The labeled faces may be removed from the display area in order to allow a new set of unlabeled faces to be added to the display area.

As indicated at 1010, the method illustrated in FIG. 10 may include recalculating, dependent on the assigned label, the similarity metrics for each pair of remaining unlabeled image elements. The image labeling system may receive, from the new labels that the user has indicated should be assigned to the one or more unlabeled image elements, additional information regarding characteristics of image elements. As an example, labels that are assigned to faces may indicate additional characteristics such as race, age and gender. The additional characteristics indicated through the labels may enable the image labeling system to more accurately determine similar image elements. Therefore, the image labeling system may recalculate the similarity metrics for each pair of the remaining unlabeled image elements. As an example, similarity engine 114 may recalculate the similarity metrics using a method similar to that described above. Recalculating the similarity metrics dependent on label information received from a user may enable the image labeling system to improve the accuracy of the display of unlabeled image elements throughout the image labeling process.

As indicated at 1020, the method illustrated in FIG. 10 may include selecting, dependent on the recalculated similarity metrics, unlabeled image elements from the remaining unlabeled image elements. For example, the image labeling system may select a set of one or more unlabeled faces for display in the display area. The image labeling system may select the one or more unlabeled faces using a method similar to that described above in reference to block 210 of FIG. 2. As described above, the one or more unlabeled faces selected for display may include unlabeled faces that have previously been displayed and unlabeled faces that have not previously been displayed.

As indicated at 1030, the method illustrated in FIG. 10 may include displaying, in the display area, dependent on the recalculated similarity metrics, the selected unlabeled image elements. Display module 116 may use a method similar to the method described above in reference to FIG. 9 to display the selected unlabeled image elements. For example, the spatial proximity in the display of each unlabeled image element to one or more displayed, labeled image elements may be dependent on the similarity metrics between the unlabeled image element and at least one of the displayed, labeled image elements. The display size of each unlabeled image element may also be dependent on the similarity metrics between the unlabeled image element and at least one of the displayed, labeled image elements. Furthermore, the unlabeled image elements may be displayed such that overlap between the unlabeled image elements is minimized.

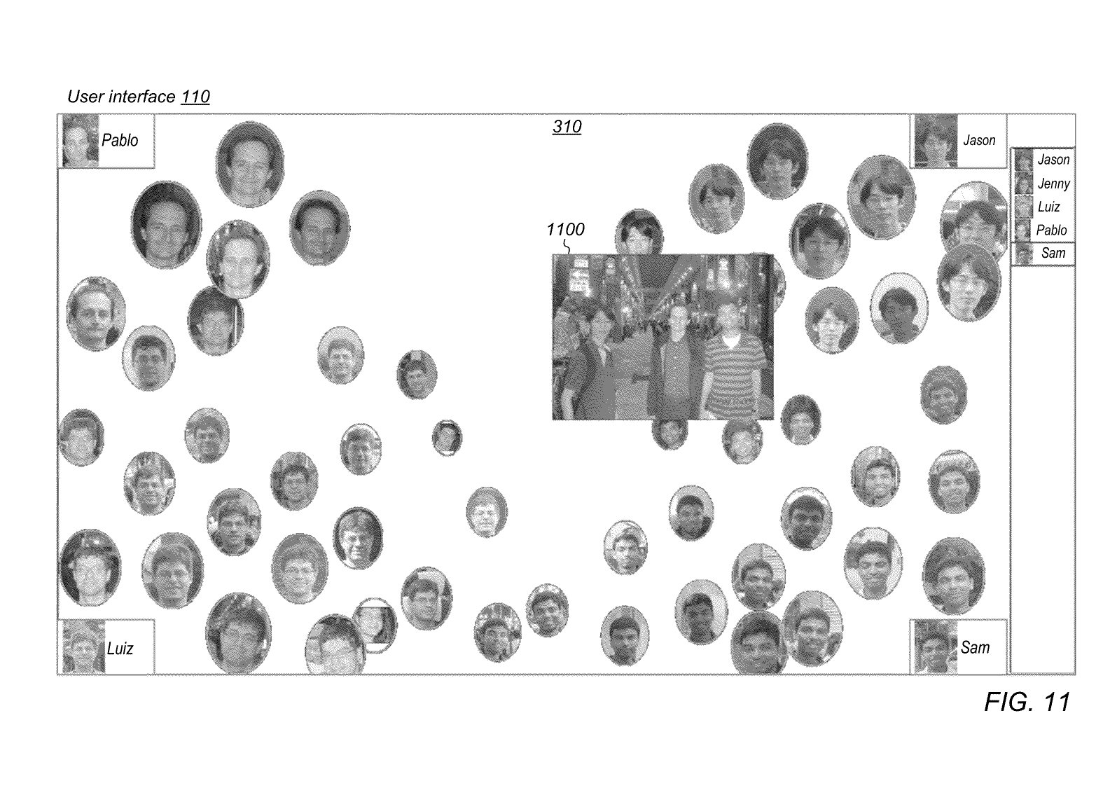

The image labeling system, in various embodiments, may provide a number of user interface, and/or control, elements for a user. As an example, a user may be unsure of the identity of a particular unlabeled face that is displayed in the display area. Image labeling module 100 may provide, via user interface 110, a mechanism via which the user may view the source image that corresponds to the unlabeled face. As an example, the user may right-click on the display of the unlabeled face and the system may display the source image for the unlabeled face. In some embodiments, the system may overlay the source image on the display of unlabeled faces. FIG. 11 illustrates an example of a source image for an unlabeled face that has been overlaid over the display of the unlabeled faces.

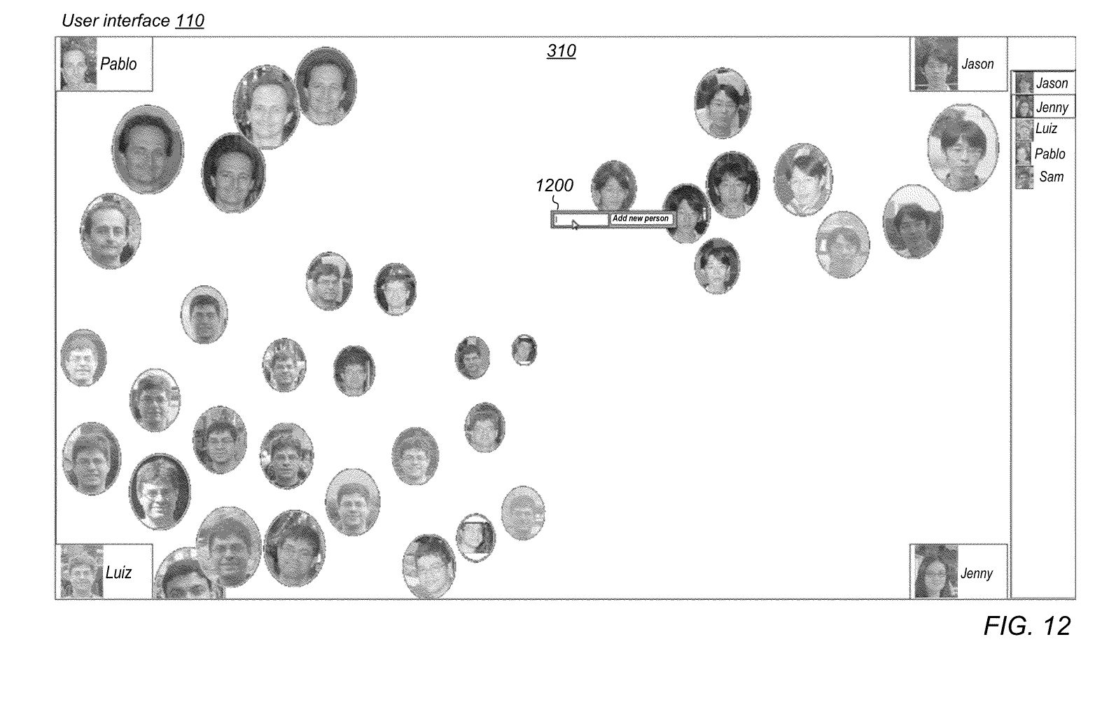

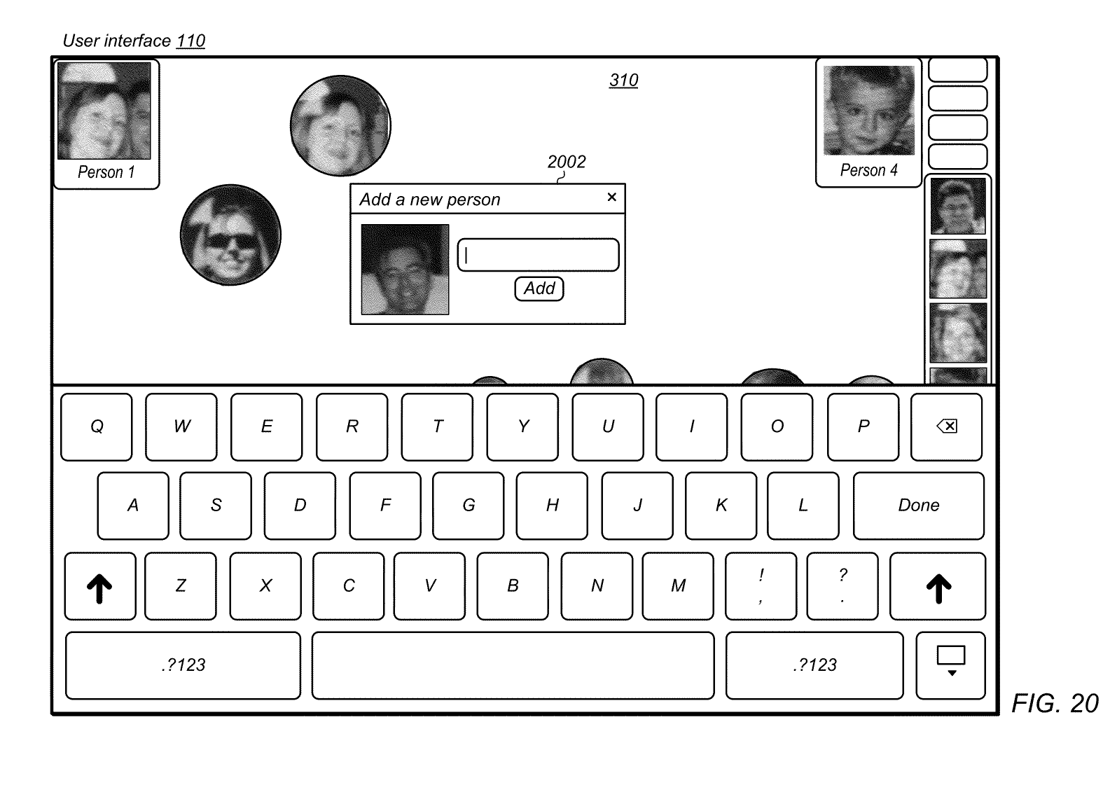

The image labeling system may also provide a mechanism through which a user may assign a label directly to a particular unlabeled image. The label that a user may assign directly to the particular unlabeled image may be a new label that the user has not previously defined. As an alternative, the label may be an existing label that the user would like to assign directly to an unlabeled image without having to first display an image which corresponds to the label. As an example, the image labeling system may enable a user to provide text input that may specify a label for an unlabeled image element. FIG. 12 illustrates an example of a user applying a label to an unlabeled face via a text entry box. As illustrated in FIG. 12, user interface 110 may display a text entry box, such as 1200, that may enable a user to enter a label for an unlabeled face. The label entered according to the user into the text entry box may be a new label or may be an existing label. The image labeling system may apply the label indicated through the user's text entry to a selected unlabeled face. Text entry box 1200 may be displayed in response to a user request to assign a label directly to an unlabeled image. For example, the user may right-click on an unlabeled face and select a menu item such as, “Assign label to face.” In other embodiments, described below, a user on a touch-sensitive device may tap and hold over the image to access text entry box 1200. A similar example is described with regard to FIG. 20 below.

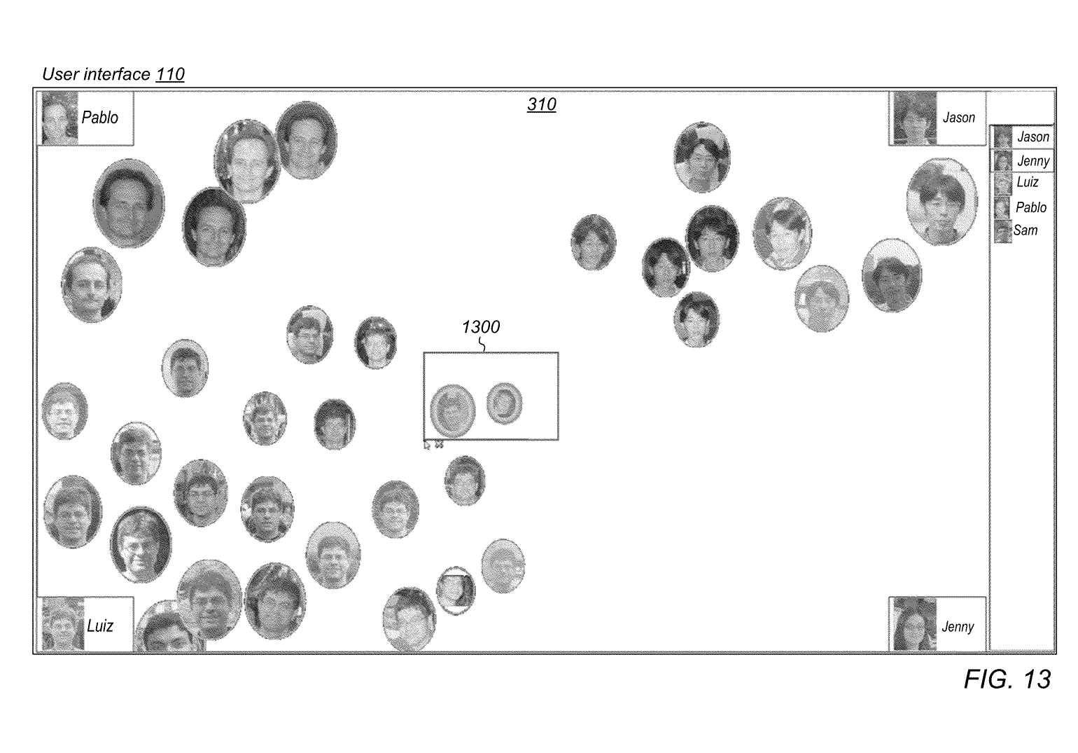

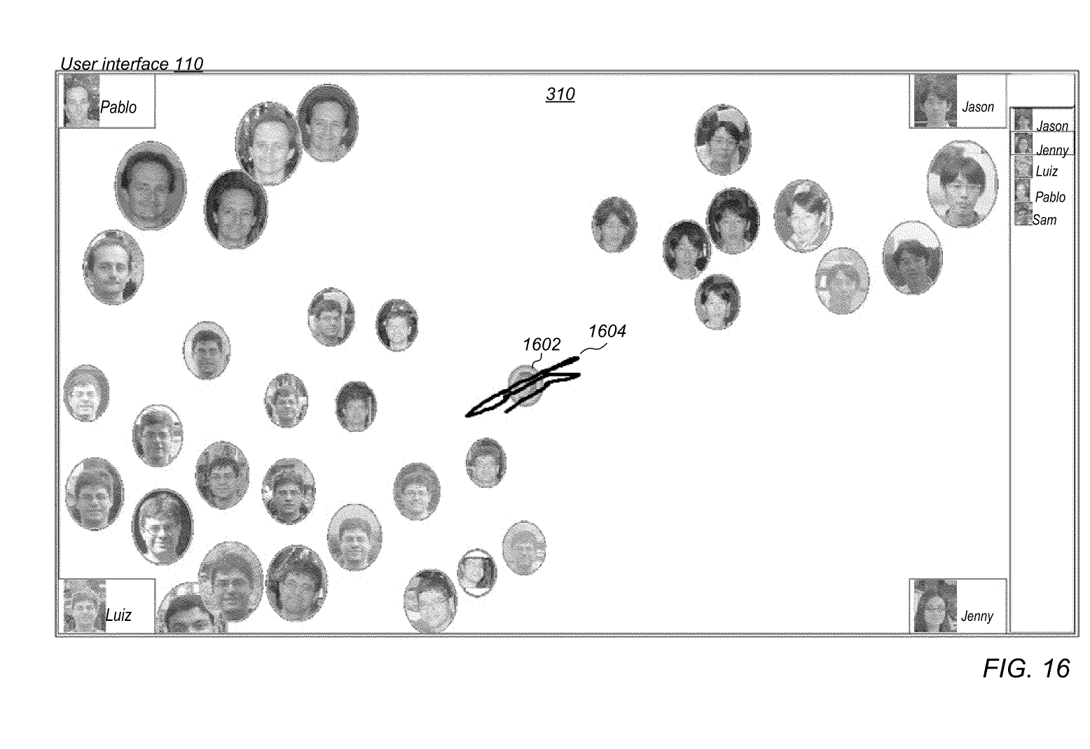

The image labeling system may also provide a mechanism through which a user may remove one or more of the unlabeled image elements from the display. FIG. 13 illustrates an example of a user selecting unlabeled image elements for removal from the display area. As illustrated in FIG. 13, the user has selected two faces for removal from the display area. The user may remove the selected faces via a variety of different mechanisms in user interface 110. For example, the user may select a menu item, such as “delete faces,” or “remove faces.” As another example, the user may press the “Delete” key on a keyboard. The selected faces may be removed from the display area and may remain as unlabeled faces in the set of detected faces. The user's removal of the unlabeled images may serve as negative feedback to the image labeling system. For example, the user removal may indicate that the removed faces are not the same as any of the labeled faces that are displayed in the display area. In other embodiments, described below, a user on touch-sensitive device may draw several back-and-forth motions over an unlabeled image to remove the unlabeled image from the display region. An example of the back-and-forth delete is described below with regard to FIG. 16.

The image labeling system may not be restricted to labeling faces in digital images. As an example, the image labeling system may be applied to labeling any content in images. As another example, the image labeling system may be applied to labeling content in video scenes. As yet another example, the image labeling system may be applied to labeling web page designs to indicate design styles for the web pages. The methods of the image labeling system described herein may be applied to any type of labeling system that is based on a similarity comparison. The image labeling system described herein may provide a system for propagating labels to a large collection of items from a small number of initial items which are given labels. The system may be applied to a collection of items for which visual representations of the items may be generated. As an example, the image labeling system may be used for classifying and/or labeling a large set of PDF files, based on similarities between visual representations of the PDF files.

In other embodiments, the image labeling system may be used to explore a large collection of images to locate a desired image. An exploration of the collection of images may be necessary, rather than a direct search, when a search query item is not available. For example, a user may want to find a particular type of beach scene with a particular palm tree in a collection of images, but may not have a source search query entry to provide to a search system. The user may just have a general idea of the desired scene. The user may use the image labeling system to narrow down the collection of images to locate the desired scene. For example, the user may select and label one beach scene in the images and place the image in one corner of the display area. The user may label other image, for example, an image of a tree scene, and place the images in other corners of the display area. In this way, a user may initiate a search for similar images using an image as the basis for the search, without the use of any text or keywords.

The user may execute the image labeling system and the system may locate images with similar beach scenes and similar tree scenes from the collection of images. The user may select some of the located images as images which are closer to the desired image and place these images in the corners of the display area and may again execute the image labeling system to locate more similar images. The user may repeat this process, continually replacing the corner images with images that are closer to the desired image. In this manner, the image labeling system may help the user converge the collection of images into a set of images that closely resemble the user's desired image. The user may continue the process until the desired image is located.

### Example Embodiment

### Interpreting Gestures to Label Images

The underlying aspects of the image labeling system described above operate equally well when used in conjunction with any device capable of receiving user input defining a gesture. However, in such cases, the user interface elements through which a user interacts with the features of the image labeling system may not be the traditional mouse and keyboard input devices. Instead, devices capable of receiving gestures as user input may provide a user with a user interface that may interpret various hand gestures to determine a corresponding image labeling task. In some embodiments, the image labeling system may be implemented without any text-based or pull-down menus. In other embodiments, a labeling operation performed is not based on any text-based or pull-down menu selections, and instead, the labeling operation is based exclusively on a gesture or gestures.

The image labeling system provides interpretation of several gestures that may be associated with one or more labeling tasks. The image labeling system may operate on a device without the use of menus. Instead, the image labeling system provides other feedback cues to a user to provide interactive visual feedback indicative of a labeling task.

In some embodiments, gesture information may be received within the image labeling system from the operating system of the device as a result of a user touching a touch-sensitive screen. In other embodiments, gesture information may be received within the image labeling system from the operating system of the device as a result of a user making hand motions that may be received through a camera or other motion detection device. For example, the image labeling system may be used with an input device that is configured to sense gesture motions in multi-dimensional space. Other forms of gesture recognition using different hardware may be used by any device capable of executing the image labeling system. For each type of gesture input and for each type of gesture, a mapping may be defined to one or more labeling tasks of the image labeling system. As another example, the image labeling system may be used with an input device configured to sense a combination of touch gestures and non-contact gestures.

In the below descriptions of labeling tasks, certain gestures have been mapped to certain labeling tasks. However, any gesture may be defined to be mapped to any labeling task, and a user may also be allowed to define additional gestures or to modify gesture mappings.

In some embodiments, when a user first runs the image labeling system, the user may choose to populate the labeled images of display region 310 with an initial set of labeled image elements. For example, the image labeling system may present a user with a set of unlabeled image elements and allow the user to label one or more of the image elements. In response to the image labeling, the image labeling system may display the labeled image elements in display region 310, and display one or more unlabeled image elements based on similarity metrics of the unlabeled image elements to the labeled image elements, as depicted in FIGS. 3 and 16.

In some embodiments, given a display region 310 with both labeled and unlabeled image elements, the image labeling system activates an interactive labeling mode upon receiving information from the device operating system upon the device operating system detecting the beginning of a gesture while the image labeling system is active. In such a case, the interactive labeling mode is active for the duration of the input gesture. In some embodiments, the interactive labeling mode is active until a corresponding labeling task is complete. Upon each additional input information update regarding the continuing gesture, the image labeling system may determine the intended labeling task based on one or more characteristics of the gesture.

In some embodiments, recognition of the gesture input provided from the device operating system may correspond to a traversal of a finite state automaton. For example, given an initial indication of a touch on the screen of the device, the image labeling system may determine over which area of the user interface the touch is received. Based on the location of the touch, certain labeling tasks may be eliminated from consideration. For example, if the user touches a labeled image, a possible interpretation of the gesture may be a relabeling of the labeled image, but a gesture such as a flick may be eliminated from consideration as a possible interpretation. Given additional input defining the characteristics of the gesture, the image labeling system may proceed to recognize the gesture in conjunction with the location touched. In this example, each labeling task would have a unique path through the finite state automaton, where the identification of the labeling task is arrived at through continuous interpretation of the gesture input. Examples of gesture input received from the device operating system include spatial coordinates such as the location on the device touched, pressure values, velocity and distance associated with each of the one or more touches of the gesture, or elapsed time for the entire gesture or for a portion of the gesture.

In some embodiments, visual feedback provided from the image labeling system may be displayed to a user while the interactive labeling mode is active. This interactive feedback may provide a user with visual cues through a modification or display of user interface elements indicating a labeling task that may be performed according to the current gesture. For example, the path of a finger as a gesture is made may be drawn across the screen.

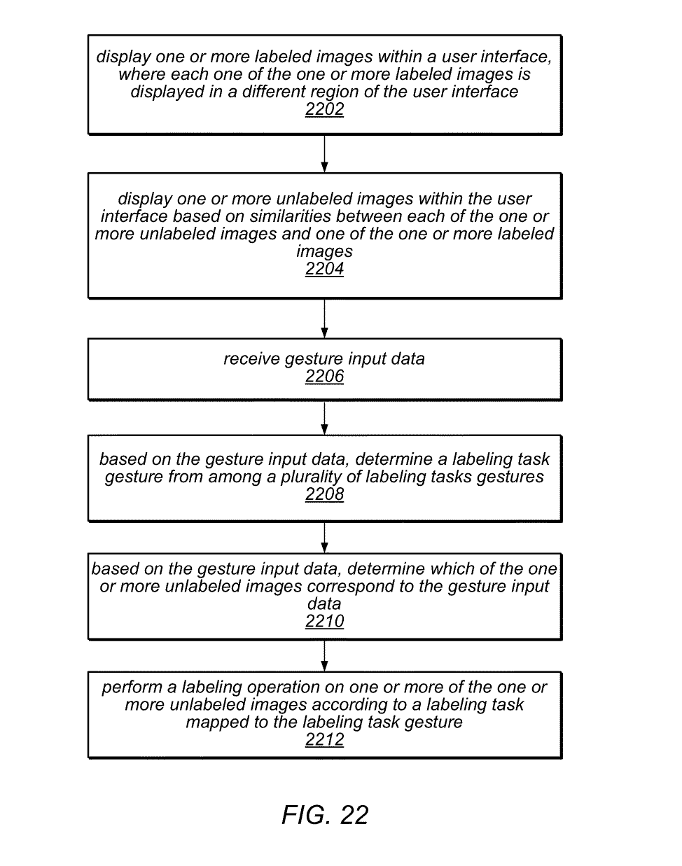

FIG. 22 depicts a flowchart presenting certain processing elements according to some embodiments of the image labeling system incorporating interpretation of gestures. The below example labeling tasks are described in the context of the user interface of the image labeling system providing a window region 310 including labeled and unlabeled images, as depicted in FIGS. 16-21. The display of one or more labeled and unlabeled images are depicted within elements 2202 and 2204 of FIG. 22. As described above, with respect to FIG. 2, the labeled images are displayed in different regions of the user interface and the unlabeled images are displayed based on similarities between each of the unlabeled images and one or more of the labeled images.

Upon receiving gesture input data, as depicted within element 2206, the image labeling system may determine a labeling task gesture from among a plurality of labeling task gestures, where the determining is based on the gesture input data, as depicted within element 2208. In addition to determining the gesture, the gesture input data may be used as the basis for determining which of the displayed one or more unlabeled images correspond to the gesture, as depicted within element 2210.

Once the labeling task gesture has been determined, a labeling task mapped to the labeling task gesture may be referenced to determine which labeling operation to perform on one or more of the unlabeled images determined to correspond to the gesture, as depicted within element 2212.

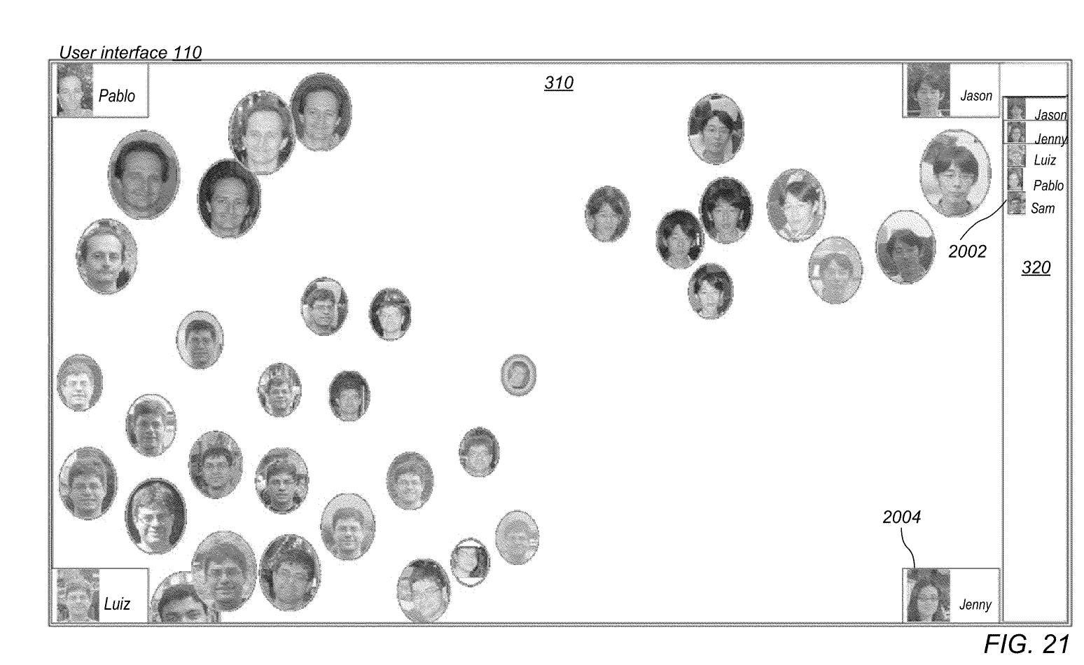

The image labeling system user interface may also provide a region of the user interface that includes other labeled images, such as window region 320 in FIG. 21, where the other labeled images may be introduced into window region 310 along with the currently displayed labeled and unlabeled images. In some embodiments, the additional labeled images not within the labeling region 310 may be automatically placed within labeling region 310 upon a currently displayed labeled image within labeling region 310 is removed due no longer having any unlabeled images match or closely match or due to an explicit removal or replacement by the user. The case when the number of unlabeled images with no matches or few low probability matches may occur after a user successfully labels most or all unlabeled images that match, at least to some degree, a labeled image.

In some embodiments, a replacement labeled image is automatically selected based on having the most probable matches of the current set of labeled images not displayed within display region 310. In other embodiments, a user may be prompted to select a labeled image to replace the labeled image being removed. In some embodiments, such as incorporation of the image labeling system within a social media application, the next image element for labeling may be suggested to the user may be based on one or more social metrics of the social media application. For example, in some cases, a next image element for labeling may be submitted to a user based on the number of matches the unlabeled image element has to existing photos in the user's image library or collection. In other examples, an unlabeled image element such as a face may be suggested based on contextual information from the image from which the unlabeled image element was drawn, such as a baseball if there are a significant number of images in the user's current library that are related to baseball or, more broadly, an encompassing category such as sports.

### Cloud Computing Environments

Touch-sensitive devices are often mobile devices with limited computational power. To overcome the computational limitations of most mobile devices, the image labeling system may access remote computer systems to perform portions or all of the computational workload. The remote computing system or systems accessed from the image labeling system may be a cloud computing environment.

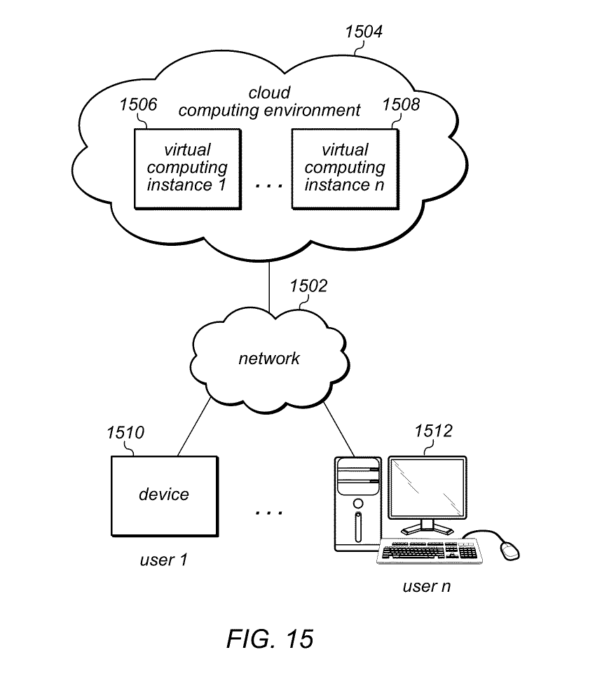

FIG. 15 depicts one possible computing environment that includes a device 1510 accessing a cloud computing environment 1504 over network 1502. Within the cloud computing environment there may be one or more virtual computing instances available to service the needs of computing device 1510, such as virtual computing instance 1506 and 1508. In one embodiment, the user interface aspects of the image labeling system may be configured to execute locally on the device and the execution of the image recognition software may be configured to execute remotely within a virtual computing instance of the cloud computing environment.

Further in regard to FIG. 15, even a traditional desktop computer 1512 may execute an implementation of the image labeling system which may access a cloud computing environment to perform some of the elements of the image labeling system.

### Delete

FIG. 16 depicts an illustration of the image labeling system corresponding to an aspect of a delete operation. The image labeling system may interpret a delete operation as consecutive back and forth swipes over a region corresponding to an unlabeled image. At the point the user touches the screen, an interactive labeling mode may be activated and as the user moves a finger across the display, the image labeling system provides continuous visual feedback with the update of a path drawn within the user interface tracking the finger motion.

As an example, a user may touch the screen on or near an unlabeled image 1602 and, without lifting a finger, move in short, quick strokes over the unlabeled image. In different embodiments, the gesture for interpreting a delete operation may defined in various ways. For example, given a touch near or on top of an unlabeled image, a user may move a finger in one stroke in an initial direction, and given subsequent back and forth strokes in the same direction as the initial stroke, a delete may be detected. In this way, consecutive vertical strokes may be used to delete an unlabeled image from the labeling region 310 of the user interface.

In some embodiments, the image labeling system may provide visual feedback such as drawing the trace of the user's finger as the finger moves back and forth executing a delete gesture, as depicted by element 1604. In other embodiments, after a delete gesture, a graphic may be drawn over the unlabeled image, such as an “X”, and the user may be prompted with a “YES” or “NO” pop up menu asking to confirm a delete operation.

In some embodiments, velocity may be used as a factor in distinguishing between a delete operation and other labeling tasks. For example, unless the velocity of user motion strokes are above a certain threshold, the strokes may not be interpreted as a delete operation. In other embodiments, any number of strokes above a certain threshold may be used to determine a delete operation. For example, two back and forth strokes may be defined to be a minimum number of strokes to be interpreted as a delete operation, or any number of strokes above three strokes.

In other embodiments, the image labeling system may specify that the strokes in a delete operation have a minimum or maximum length. In other embodiments, the image labeling system may specify that at least one stroke in a delete operation be over the unlabeled imaged intended to be deleted. In other embodiments, the delete operation may apply to the nearest unlabeled image, even if the delete strokes did not touch the unlabeled image. In some embodiments, a trash can icon may be displayed in any part of labeling region 310 or region 320, and a drag of the unlabeled image onto the trash can accomplishes the delete operation.

In some embodiments, the delete gesture may apply to more than one unlabeled image. For example, since images with similar characteristics may be located within the same region of the screen, similar images may be equally inapplicable to the current labeled images. In this example, if two unlabeled images are adjacent or near each other, and multiple delete swipes encompass both unlabeled images, then both unlabeled images may be removed from labeling region 310.

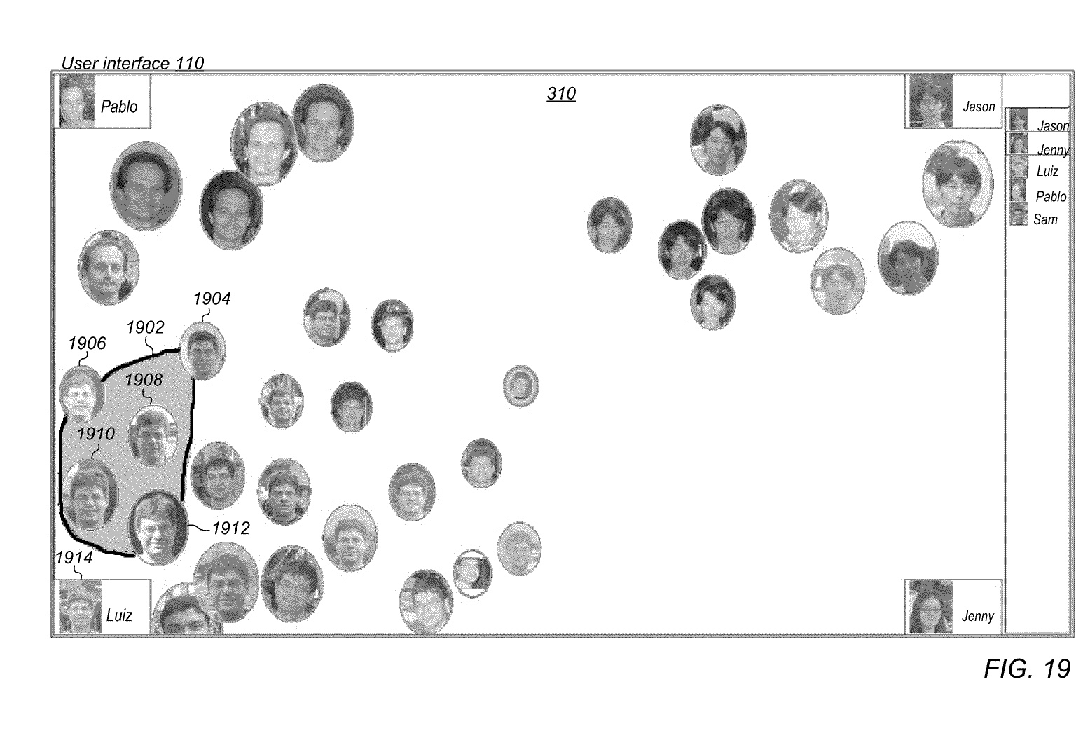

In one embodiment, multiple unlabeled images may be deleted through a combination of gestures. For example, a user may press a finger down on an unlabeled image, or near an unlabeled image, as with unlabeled image 1904 of FIG. 19. The user may then, without lifting the finger, trace the path of line 1902, which encompasses unlabeled images 1904, 1906, 1908, 1910, and 1912. When the user's finger returns to within a pre-defined proximity of the starting point of line 1902, the user may, while maintaining contact with the screen execute a delete gesture of multiple back and forth strokes. As a result, each of the unlabeled images 1904, 1906, 1908, 1910, and 1912 may be deleted. Without the final delete gesture, a different labeling task may be determined, as is described below with respect to the lasso operation.

### Flick

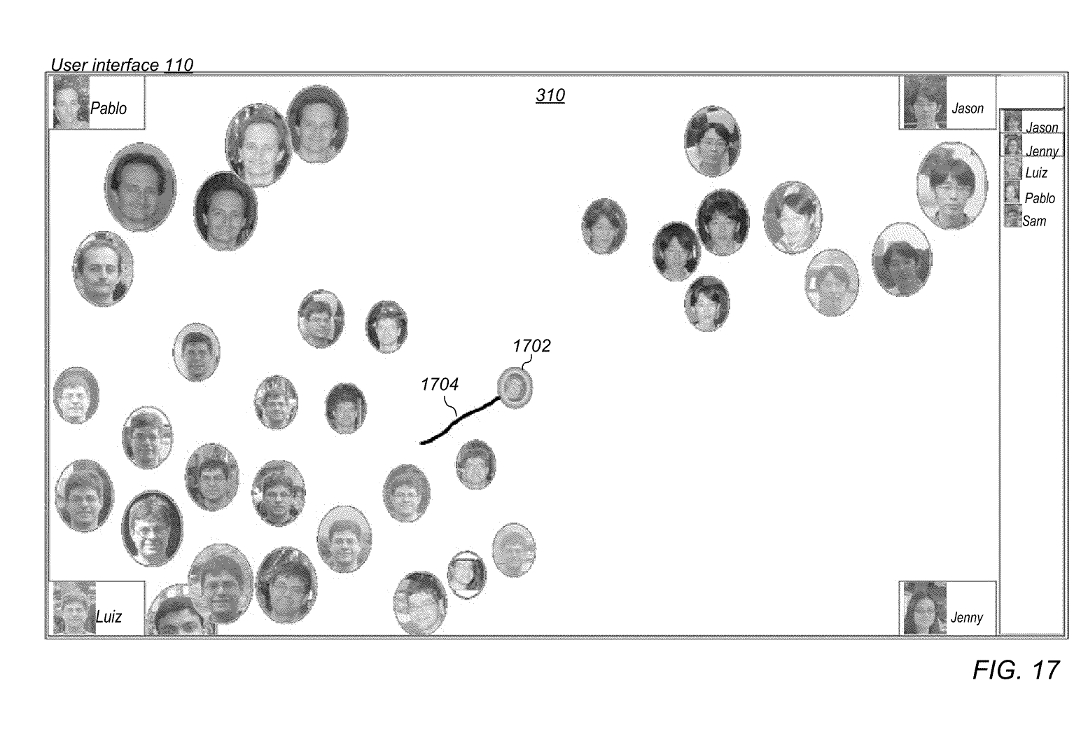

A flick gesture may be interpreted to be a gesture that begins with a screen touch and where the touch becomes a quick movement across a short distance of the screen. FIG. 17 depicts the feedback line 1704 drawn to reflect the flick of the unlabeled image in the direction of the labeled image in the bottom left corner of the user interface. At the point the user touches the screen, the interactive labeling mode may be activated and as the user moves a finger across the display, the image labeling system provides continuous visual feedback such as updating a path drawn within display region 310.

As an example, in FIG. 17 a user has placed a finger over the unlabeled image 1702 and as the user moved a finger in the direction of the bottom left labeled image, the image labeling system draws a line on the user interface tracing the path of the user's finger movement. The end of the drawn line is the point at which the user lifted a finger from the screen. At this point, the direction of the gesture is interpreted to determine the labeled image nearest the trajectory endpoint the unlabeled image would have taken if it had been physically flicked with the user's finger. As additional user feedback, the user interface may continuously redraw the unlabeled image as the unlabeled image follows the trajectory of the flick gesture toward the labeled image. In some embodiments, the labeled image whose label is to be applied to the flicked unlabeled image may be highlighted.

In some embodiments, a user may drag a finger across multiple unlabeled images and as a last gesture before lifting a finger from the screen, the user may flick in the direction of a labeled image. In this case, each of the unlabeled images along the path may be labeled with the label of the labeled image nearest the receiving end of the trajectory of the flick gesture at the end of the path.

As described above, given each newly labeled image or images, the image recognition software may be provided the newly labeled images as training images, and the image recognition software may recalculate the probabilities of similarity of the remaining unlabeled images.

### Path Select

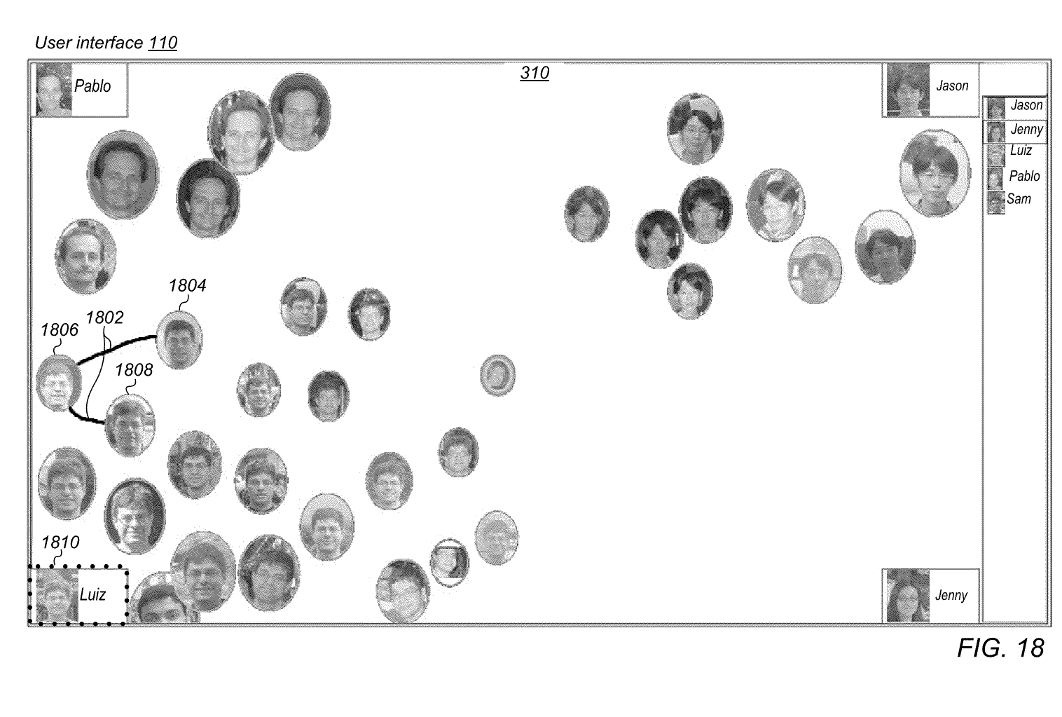

It may often be the case that several unlabeled images may be displayed within display region 310 of the image labeling system in close proximity because each of the unlabeled images has a similar labeling confidence based on calculated similarity metrics. As depicted in FIG. 18, a user began a gesture with touching down on unlabeled image 1804 and while maintaining contact with the screen, the user moved the finger down over unlabeled image 1806 and continued until the user's finger was over unlabeled image 1808. In some embodiments, at the point the user touches the screen, the interactive labeling mode may be activated and as the user moves a finger across the display, the image labeling system provides continuous visual feedback such as updating a path drawn within the user interface.

In this example, as the user's finger moves across unlabeled images 1804, 1806, and 1808, the image labeling system draws the path according to line 1802. At the point the user touched the screen, the interactive labeling mode was activated and the user traced a finger across unlabeled images 1804, 1806, and 1808, the image labeling system provides continuous visual feedback such as updating the path drawn within the user interface.

In some embodiments, additional visual feedback may be provided to the user while in the interactive labeling mode such as reshaping the bubble of the unlabeled image to include a tapered point that points in the direction of the labeled image corresponding to the current best match of the image recognition software. In this example, upon a finger being lifted from the screen, unlabeled images 1804, 1806, and 1808 may be applied with the label corresponding to labeled image 1810, which would be the labeled image being pointed at by the tapered points of the images along path 1802. At this point images 1804, 1806, and 1808 may be labeled and removed from display region 310 and replaced with additional unlabeled images.

In some embodiments, additional visual feedback may be provided to the user during the interactive labeling mode such as highlighting the labeled image corresponding to the current best match of the image recognition software. For example, the border surrounding labeled image 1810 may be highlighted with a coloration of the border that is different from the other labeled images in the user interface, represented in FIG. 18 as a dotted line. At the deactivation of the interactive labeling mode, the highlighting around the labeled image may be removed. In some embodiments, only those unlabeled images directly touching the path are selected to be labeled.

In some embodiments, while the interactive labeling mode is active and the unlabeled images along the path are indicated as selected, a user may, prior to lifting the path tracing finger, flick the finger toward any labeled image. In this case, instead of labeling the unlabeled images with the label of the nearest labeled image, the unlabeled images may be labeled with the label of a labeled image that is along the trajectory of the flick motion. Further in this embodiment, the flick may be visually represented within the user interface with a line on the screen drawn to correspond to the flick direction.

### Lasso Select

As with the path select labeling operation, it may often be the case that several unlabeled images may be displayed within the user interface of the image labeling system in close proximity because each of the unlabeled images has a similar labeling confidence of a match. However, in the lasso selection operation, a user may select multiple unlabeled images without tracing over each image. Instead, a user may trace a lasso through and/or around the unlabeled images the user wishes to select, and upon completing the selection and lifting a finger from the screen, the selected unlabeled images may be labeled with the label of the nearest labeled image on the screen.

In this example, the interactive labeling mode is activated upon detecting a finger touch on the screen. At the instant that the touch is detected, it is not yet possible to disambiguate between any of the possible labeling tasks. However, as the user moves a finger and traces a path it becomes possible to determine the labeling operation intended. For example, if a user traces a path that ends within a pre-defined proximity to the beginning of the path, a lasso operation is determined and any unlabeled images within the path or touching the path are selected for labeling. If the ending of the path were outside the pre-defined proximity to the beginning of the path, then a path selection operation may be determined as described above.

In some embodiments, interactive feedback is provided to the user in the form of visual cues drawn within the user interface of the image labeling system. As depicted in FIG. 19, the path traced according to user input is drawn with line 1902. In this example, the region enclosed within the lasso is filled in a gray background to indicate the region of the lasso selection area. Each of the unlabeled images within the lasso selection area, upon deactivation of the interactive labeling mode in response to the user lifting the finger tracing the path are labeled according to the label of the nearest labeled image. In this example, unlabeled images 1904, 1906, 1908, 1910, and 1912 are labeled according to label 1914, which is the nearest labeled image to the lassoed unlabeled images.

In some embodiments, while the interactive labeling mode is active and the unlabeled images within the lasso selection region displayed with a gray background, a user may, prior to lifting the tracing finger, flick the finger toward any labeled image. In this case, instead of labeling the unlabeled images with the label of the nearest labeled image, the unlabeled images may be labeled with the label of a labeled image that is along the trajectory of the flick motion. Further in this embodiment, the flick may be visually represented within the user interface with a drawing on the screen of a line corresponding to the flick direction.

Given that in some embodiments the proximity of an unlabeled image on the screen is proportional to the confidence of the image recognition software of a match, this multiple image flick allows a user to label multiple images that are placed near a labeled image which does correspond to the proper labeling of the unlabeled image.

### Labeling and Relabeling

The image labeling system allows a user to label an image when the first labeled images are selected, as described above. However, the image labeling system also allows a user to rename or relabel an already labeled image. For example, as depicted in FIG. 20, a keyboard may be displayed over a portion of the user interface to allow the user to enter a new label name.

In one embodiment, the interactive labeling mode is activated upon a finger touch, and if a user holds down a finger for a period of time, the image labeling system determines that a relabeling task is intended. Upon determining that a relabeling task is intended, a keyboard is displayed to allow the user to enter a new label name. Once the new label name has been entered, the new label name is applied to the image and all previously labeled images with the same label name are also relabeled. In some embodiments, the image over which the user pressed a finger is displayed alongside an entry box to present a visual association of the new label with the image to which the label may be applied, as depicted within labeling window 2002.

In some embodiments, the same touch and hold gesture may be used to label unlabeled images. This feature may be useful in cases where an unlabeled image does not match a currently displayed labeled image and the unlabeled image is either the only image of its kind or only one of a few images of its kind. In this case, it may be efficient to simply apply a label to the unlabeled image directly.

In some embodiments, in response to displaying a keyboard, the display area is reconfigured to a smaller space. For example, the labeled and unlabeled images are redrawn in the smaller space such that their positions respective of the original layout are preserved.

### Tap

Another gesture that may be interpreted into a labeling task is a tap gesture. A tap may be interpreted as a quick touch and finger lift. At the initial touch of the screen, the interactive labeling mode is activated and if the duration of the touch is only a short, amount of time defined before the gesture began, then the labeling task is determined to be the labeling of the unlabeled tapped image with the label of the nearest labeled image within display region 310.

In some embodiments, the border of the unlabeled image may be momentarily highlighted. In other embodiments, the unlabeled image may be redrawn as it moves across the screen until it reaches the nearest labeled image, at which point the unlabeled image may disappear. This visual feedback may provide assurance to the user regarding the labeled image whose label is applied to the unlabeled image.

### Context Zoom

Another gesture that may be interpreted into a labeling task is a two-finger expansion over an unlabeled image. As an example layout of unlabeled images within user interface region 310 of FIG. 19, only the faces within a bubble-shaped image are displayed. If a user would like additional context in order to help identify the unlabeled image, the user may touch down two fingers on top of or surrounding the unlabeled image. Upon contact of the two fingers, the interactive labeling mode is activated and when the user spreads apart the two fingers the labeling task is determined to be a context zoom. In executing the context zoom, the image labeling system increases the display area of the unlabeled image to display elements of the image from which the unlabeled image has been drawn. For example, if the unlabeled image displayed was extracted from a photo with a backdrop of the Eiffel Tower and other people in the photo, the additional context may help the user identify the unlabeled image.

The image labeling system may increase the context from the original photo until the entire original photo is displayed. Further, the interactive labeling mode may remain activated while the user spreads apart and draws together the two fingers, and the image labeling system may continue to increase or decrease the displayed context in response. The interactive labeling mode may be deactivated in response to the user lifting the two fingers from the screen.

In addition to the visual contextual information, metadata corresponding the original image may also be displayed. For example, the time and date, or if available, the location, or the name of the folder or location of the image, or the corresponding photographic settings, such as the device that took the image, and the shutter speed, ISO, or exposure information.

After the temporary increase in context has been displayed to the user, the user may proceed to label the unlabeled image using the previously described gestures.

### Replace Labeled Image

FIG. 21 depicts a labeling region 310 that includes four labeled images in the four corners of the display area. Also displayed within the user interface of the image labeling system is a panel 320 that includes other labeled images. Image labeling system allows a user to either swap out a labeled image or to add a new labeled image to labeling region 310.

To swap out a currently displayed labeled image in display region 310, a user may touch down on the screen in the region displaying labeled image 2002 in panel 320. While maintaining the touch on top of the labeled image 2002, the user may drag labeled image 2002 on top of one of the currently displayed labeled images in display region 310, such as labeled image 2004. Once the labeled image has been dragged on top of currently displayed labeled image 2004, the user may lift their finger and in response, currently displayed labeled image 2004 may be replaced with labeled image 2002.

In other embodiments, instead of replacing a currently displayed labeled image, a user may drag a labeled image from panel 320 into labeling region 310 of the display. Upon the user lifting their finger and completing the drag gesture, the new labeled image may be dropped and drawn into labeling region 310 at the position where the drag gesture ended, without replacing any currently displayed labeled images.

Once the newly labeled image has been introduced into labeling region 310, new unlabeled images determined to match the newly labeled image to some degree may now be introduced into labeling region 310. Further in response to introducing the new labeled image, the previously displayed unlabeled images are rearranged to accommodate the new unlabeled images.

In other embodiments, a user may perform a delete gesture over a currently displayed labeled image, and in response, image labeling system may replace the deleted labeled image with a labeled image from user interface panel 320. For example, the labeled image at the top of the panel may be determined to be the next labeled image to display, in other cases, the labeled image with the greatest quantity of potential matches is selected to be displayed next.

In other embodiments, a user may flick an image element from user interface panel 320 into display region 310 to replace a currently displayed labeled image. For example, if a user flicks image element 2002 toward image element 2004, image element 2004 in display region 310 may be replaced with image element 2002.

### Accelerometer

Some devices implementing the image labeling system may include accelerometers, which may provide applications installed on the device with information regarding a direction and amount of motion of the device. The image labeling system may receive and interpret accelerometer information as a gesture or as a modification to a gesture.

The image labeling system may receive information from the device accelerometer in order to perform a subset of the labeling tasks described above. In one embodiment, given unlabeled and labeled images within a display area 310 as in FIGS. 16-21, a user may move the device on which the image labeling system is operating in a direction x, for a distance d, and for an amount of time t. In this example, each unlabeled image may be assigned an amount of inertia prior to the movement, and in some cases, the amount of inertia may be defined to be inversely proportional to the display size of the unlabeled image. In this way, images with a greater likelihood of a match would move more readily than images determined to less likely match a given labeled image. Each unlabeled image may then be moved in the direction x of the nearest labeled image based on an amount proportional to the amount of inertia of an unlabeled image multiplied by the force of movement as calculated using distance d and time t. In this way, a slight movement may move the larger unlabeled images farther than the smaller unlabeled images, resulting in applying the nearest label corresponding to direction x to unlabeled images with a high probability of matching. A more dramatic movement may result in both the larger and smaller unlabeled images being labeled, which may possibly introduce some labeling errors since even unlabeled images with lower probabilities of a match may be labeled. However, dramatic movements may allow a user to more quickly label a larger amount of unlabeled images.

In some embodiments, the image labeling system may either define a threshold of movement or allow a user to disable accelerometer responses. The pre-defined threshold may be useful to distinguish between small, constant movements of the device that are part of normal user handling and between sharper, jarring motions that may more confidently be identified as movement intended to serve as a labeling operation.

### Gyroscope

Some devices implementing the image labeling system may include gyroscopes, which may provide applications installed on the device with information regarding roll, pitch, and yaw of the device. The image labeling system may receive and interpret gyroscope information as a gesture or as a modification to a gesture.

In one embodiment, given unlabeled and labeled images within a display area 310 as in FIGS. 16-21, a user may, beginning with the device in a level state, tilt the device down and in the direction of one of the labeled images. The tilting may be interpreted as a gesture, and in response the image labeling system may move each of the unlabeled images in the direction of the tilt. The speed of movement of the unlabeled images may be determined in proportion to the amount of tilt. As each unlabeled image moves toward a labeled image, the unlabeled image may be updated in the display area 310 to be closer to the labeled image. At the point that an unlabeled image reaches a labeled image, the unlabeled image may be labeled with the label of the labeled image and the newly labeled image may be removed from the display area. In some embodiments, as each unlabeled image is labeled, new unlabeled images may appear in the display area 310. As an analogy, each of the unlabeled images may be likened to a marble on a flat surface, where the flat surface has a hole in a corner corresponding to a label, and tilting the flat surface in the direction of the hold results in the marbles moving toward the hole, and when upon reaching the hole, disappearing into the hole or being labeled.

In this example, if the user decides to change the tilt direction and tilt toward a different labeled image, the movement of the unlabeled images may be updated to reflect the new tilt direction.

### Example System

Various components of embodiments of methods as illustrated and described in the accompanying description may be executed on one or more computer systems, which may interact with various other devices. One such computer system is illustrated within FIG. 14. In different embodiments, computer system 1400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1400 includes one or more processors 1410 coupled to a system memory 1420 via an input/output (I/O) interface 1430. Computer system 1400 further includes a network interface 1440 coupled to I/O interface 1430, and one or more input/output devices 1450, such as cursor control device 1460, keyboard 1470, multitouch device 1490, and display(s) 1480. In some embodiments, it is contemplated that embodiments may be implemented using a single instance of computer system 1400, while in other embodiments multiple such systems, or multiple nodes making up computer system 1400, may be configured to host different portions or instances of embodiments. For example, in one embodiment some elements may be implemented via one or more nodes of computer system 1400 that are distinct from those nodes implementing other elements.

In various embodiments, computer system 1400 may be a uniprocessor system including one processor 1410, or a multiprocessor system including several processors 1410 (e.g., two, four, eight, or another suitable number). Processors 1410 may be any suitable processor capable of executing instructions. For example, in various embodiments, processors 1410 may be general-purpose or embedded processors implementing any of a variety of instruction set architectures (ISAs), such as the x86, PowerPC, SPARC, or MIPS ISAs, or any other suitable ISA. In multiprocessor systems, each of processors 1410 may commonly, but not necessarily, implement the same ISA.

In some embodiments, at least one processor 1410 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1420 may be configured to store program instructions and/or data accessible by processor 1410. In various embodiments, system memory 1420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1420 as program instructions 1425 and data storage 1435, respectively. In other embodiments, program instructions and/or data may be received, sent or stored upon different types of computer-accessible media or on similar media separate from system memory 1420 or computer system 1400. Generally speaking, a computer-accessible medium may include storage media or memory media such as magnetic or optical media, e.g., disk or CD/DVD-ROM coupled to computer system 1400 via I/O interface 1430. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1440.

In one embodiment, I/O interface 1430 may be configured to coordinate I/O traffic between processor 1410, system memory 1420, and any peripheral devices in the device, including network interface 1440 or other peripheral interfaces, such as input/output devices 1450. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. In addition, in some embodiments some or all of the functionality of I/O interface 1430, such as an interface to system memory 1420, may be incorporated directly into processor 1410.

Network interface 1440 may be configured to allow data to be exchanged between computer system 1400 and other devices attached to a network, such as other computer systems, or between nodes of computer system 1400. In various embodiments, network interface 1440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1450 may, in some embodiments, include one or more display terminals, keyboards, keypads, touchpads, scanning devices, voice or optical recognition devices, or any other devices suitable for entering or retrieving data by one or more computer system 1400. Multiple input/output devices 1450 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1440.

As shown in FIG. 14, memory 1420 may include program instructions 1425, configured to implement embodiments of methods as illustrated and described in the accompanying description, and data storage 1435, comprising various data accessible by program instructions 1425. In one embodiment, program instructions 1425 may include software elements of methods as illustrated and described in the accompanying description. Data storage 1435 may include data that may be used in embodiments. In other embodiments, other or different software elements and/or data may be included.

Those skilled in the art will appreciate that computer system 1400 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A computer-implemented method, comprising:
displaying one or more labeled images within a user interface,
wherein each one of the one or more labeled images is displayed in a different region of the user interface;
displaying one or more unlabeled images within the user interface based on similarities between each of the one or more unlabeled image and one of the one or more labeled images;
receiving gesture input data;
based on the gesture input data, determining a labeling task gesture from among a plurality of labeling task gestures; and
performing a labeling operation on one or more of the one or more unlabeled images according to a labeling task mapped to the labeling task gesture.

2. The computer-implemented method of claim 1, further comprising:
concurrent with said performing of the labeling operation, updating one or more elements of the user interface,
wherein the one or more elements of the user interface provide visual cues corresponding to the labeling task

3. The computer-implemented method of claim 1, wherein said determining further comprises:
using location information from the gesture input data with respect to the one or more unlabeled images and a labeled image of the one or more labeled images to determine an assignment of the label of the labeled image to the one or more unlabeled images.

4. The computer-implemented method of claim 1, wherein said performing depends on gesture input data defining coordinate data and velocity data.

5. The computer-implemented method of claim 1, wherein the gesture input data comprises data defining a plurality of gestures.

6. The computer-implemented method of claim 5, wherein a first gesture of the plurality of gestures selects the one or more unlabeled images and a second gesture corresponds to the labeling operation.

7. The computer-implemented method of claim 1, wherein the labeling operation is performed without any corresponding text-based menu option selections.

8. A non-transitory computer-readable storage medium storing program instructions executable on a computer to implement an image labeling module that during operation:
displays one or more labeled images within a user interface,
wherein each one of the one or more labeled images is displayed in a different region of the user interface;
displays one or more unlabeled images within the user interface based on similarities between each of the one or more unlabeled image and one of the one or more labeled images;
receives gesture input data;
based on the gesture input data, determines a labeling task gesture from among a plurality of labeling task gestures; and
performs a labeling operation on one or more of the one or more unlabeled images according to a labeling task mapped to the labeling task gesture.

9. The non-transitory computer-readable storage medium of claim 8, wherein the image labeling module is further operable to:
concurrent with said performing of the labeling operation, update one or more elements of the user interface,
wherein the one or more elements of the user interface provide visual cues corresponding to the labeling task

10. The non-transitory computer-readable storage medium of claim 8, wherein determining the labeling task from among the plurality of labeling task gestures comprises:
using location information from the gesture input data with respect to the one or more unlabeled images and a labeled image of the one or more labeled images to determine an assignment of the label of the labeled image to the one or more unlabeled images.

11. The non-transitory computer-readable storage medium of claim 8, wherein performing the labeling operation depends on gesture input data defining coordinate data and velocity data.

12. The non-transitory computer-readable storage medium of claim 8, wherein the gesture input data comprises data defining a plurality of gestures.

13. The non-transitory computer-readable storage medium of claim 12, wherein a first gesture of the plurality of gestures selects the one or more unlabeled images and a second gesture corresponds to the labeling operation.

14. The non-transitory computer-readable storage medium of claim 8, wherein the labeling operation is performed without any corresponding text-based menu option selections.

15. A system, comprising:
a memory; and
one or more processors coupled to the memory, wherein the memory stores program instructions executable by the one or more processors to implement an image labeling module that, during operation:
displays one or more labeled images within a user interface,
wherein each one of the one or more labeled images is displayed in a different region of the user interface;
displays one or more unlabeled images within the user interface based on similarities between each of the one or more unlabeled image and one of the one or more labeled images;
receives gesture input data;
based on the gesture input data, determines a labeling task gesture from among a plurality of labeling task gestures; and
performs a labeling operation on one or more of the one or more unlabeled images according to a labeling task mapped to the labeling task gesture.

16. The system of claim 15, wherein the image labeling module is further operable to:
concurrent with said performing of the labeling operation, update one or more elements of the user interface,
wherein the one or more elements of the user interface provide visual cues corresponding to the labeling task

17. The system of claim 15, wherein determining the labeling task from among the plurality of labeling task gestures comprises:
using location information from the gesture input data with respect to the one or more unlabeled images and a labeled image of the one or more labeled images to determine an assignment of the label of the labeled image to the one or more unlabeled images.

18. The system of claim 15, wherein performing the labeling operation depends on gesture input data defining coordinate data and velocity data.

19. The system of claim 15, wherein the gesture input data comprises data defining a plurality of gestures.

20. The system of claim 19, wherein a first gesture of the plurality of gestures selects the one or more unlabeled images and a second gesture corresponds to the labeling operation.
